(19) United States
(12) Patent Application Publication
(10) Pub. No.: US 2023/0126366 A1
(43) Pub. Date: Apr. 27, 2023

(54) CAMERA RELOCALIZATION METHODS FOR REAL-TIME AR-SUPPORTED NETWORK SERVICE VISUALIZATION

(71) Applicant: Nokia Solutions and Networks Oy, Espoo (FI)

(72) Inventors: Qi LIAO, Stuttgart (DE); Tianlun HU, Stuttgart (DE)

(21) Appl. No.: 17/906,430

(22) PCT Filed: Mar. 24, 2020
(86) PCT No.: PCT/EP2020/058111

§ 371 Date: Sep. 15, 2022

(51) Int. Cl. G06T 7/70; G06T 5/50; G06T 7/20; G06T 7/593; G06V 10/82; G01J 5/48

(52) U.S. Cl. CPC G06T 7/70; G06T 5/50; G06T 7/20; G06T 7/593; G06V 10/82; G01J 5/48; G06T 2207/20081; G06T 2207/20221

(57) ABSTRACT

An apparatus, comprising: at least one processing circuitry, and at least one memory for storing instructions to be executed by the processing circuitry, wherein the at least one memory and the instructions are configured to, with the at least one processing circuitry, cause the apparatus at least to: input display data obtained from a first terminal endpoint device located in a first three-dimensional environment into a deep neural network model for terminal endpoint device pose estimation, the display data comprising at least image data of a captured image of at least part of the first three-dimensional environment acquired by the first terminal endpoint device at a first point of time and sensory data indicative of at least a motion vector of a movement of the first terminal endpoint device in the three-dimensional environment acquired by the first terminal endpoint device at a second point of time, the deep neural network model being trained with, as model input, training image data of a captured training image of at least part of a three-dimensional training environment acquired by a training terminal endpoint device located in the three-dimensional training environment and training sensory data indicative of at least a motion vector of a movement of the training terminal endpoint device in the three-dimensional training environment and, as model output, training poses of the training terminal endpoint device in the three-dimensional training environment, and obtain from the deep neural network model for terminal endpoint device pose estimation, based on the input display data, a first estimated pose of the first terminal endpoint device in the first three-dimensional environment.

### FIELD

The present disclosure relates to camera relocalization for real-time AR-supported network service visualization.

Examples of embodiments relate to apparatuses, methods and computer program products relating to camera relocalization for real-time AR-supported network service visualization.

### BACKGROUND

Camera pose estimation can be classified into two types of problems, depending on the availability of data. In case the user enters an unknown environment for the first time, and no prior data is available, the problem is called camera localization. Such problem can be solved by the well-known visual-based simultaneous localization and mapping (SLAM) techniques, which estimate the camera pose at the same time when updating a map [AT+17]. A common method in SLAM is to find the correspondences between local features extracted from 2D image and 3D point cloud of the scene obtained from structure from motion (SfM), and recover the camera pose with such 2D-3D matches. However, such feature matching-based approaches does not work robustly and accurately in all scenarios, e.g., changing lighting conditions, textureless scenes, or repetitive structures. Moreover, in case that a user enters an environment where a prior map (or part of the map) has been previously learned, SLAM still needs to create the point cloud and estimate the camera pose from scratch. This is because, visual-based SLAM usually builds a map based on a reference coordinate system, e.g., based on the camera pose of the initial frame, and every following frame is expressed relative to the initial reference coordinate system. Each time when a device enters an environment and executes the SLAM algorithm, the algorithm may build a map with respect to a different reference coordinate system.

Thus, there is need provide a solution to the second type of pose estimation problems, which is camera relocalization, i.e. estimating a camera pose in real-time in the same or similar environment.

Efficiently solving this problem is essential for enabling real-time AR features in the network service of performance visualization.

### REFERENCES

[AD+19] Android Developer, Motion sensors, https://developerandroid.com/guide/topics/sensors/sensors_motion, visited on Dec. 7, 2019
[AT+17]: R. Mur-Artal and J. D. Tardós, “ORB-SLAM2: an open-source SLAM system for monocular, stereo, and RGB-D cameras,” IEEE Transactions on Robotics, vol. 33, no. 5, pp. 1255-1262, 2017
[BGK+18] S. Brahmbhatt, J. Gu, K. Kim, J. Hays, and J. Kautz, “Geometry-aware learning of maps for camera localization,” IEEE Conference on Computer Vision and Pattern Recognition (CVPR), 2018
[JDV+13] C. Jaramillo, I. Dryanovski, R. G. Valenti and J-Xiao, “6-DoF pose localization in 3D point-cloud dense maps using a monocular camera,” IEEE International Conference on Robotics and Biomimetics (ROBIO), 2013
[KC+17] A. Kendall and R. Cipolla, “Geometric loss functions for camera pose regression with deep learning,” IEEE Conference on Computer Vision and Pattern Recognition (CVPR), 2017
[LS+18]: Q. Liao and A. Shankar, “Network Planning and Optimization Based on 3D Radio Map Reconstruction”, NC105328, patent filed on 2018 Mar. 16
[NH+11] R. A. Newcombe and et al, “Kinectfusion: Real-time dense surface mapping and tracking,” ISMAR, Vol. 11, No. 2011, pp. 127.136, 2011
[PQ+10] S. J. Pan and Q. Yang, “A survey on transfer learning”, IEEE Trans. on Knowledge and Data Engineering, 22(10), pp. 1345-1359, 2010
[W3+19] The World Wide Web Consortium (W3C), Motion sensors, http://www.w3.org/TR/motion-sensors/, visited on Dec. 7, 2019

The following meanings for the abbreviations used in this specification apply:
2G Second Generation
3G Third Generation
3GPP 3rd Generation Partnership Project
3GPP2 3rd Generation Partnership Project 2
4G Fourth Generation
5G Fifth Generation
AP Access Point
AR Augmented Reality
BS Base Station
CNN Convolutional Neural Network
DNN Deep Neural Network
DoF Degree of Freedom
DSL Digital Subscriber Line
EDGE Enhanced Data Rates for Global Evolution
eNB Evolved Node B
ETSI European Telecommunications Standards Institute
GPRS General Packet Radio System
gNB gNodeB
GSM Global System for Mobile communications
IEEE Institute of Electrical and Electronics Engineers
IETF Internet Engineering Task Force
IMU Inertial Measurement Units
ISDN Integrated Services Digital Network
ITU International Telecommunication Union
LSTM Long Short-Term Memory
LTE Long Term Evolution
LTE-A Long Term Evolution-Advanced
MANETs Mobile Ad-Hoc Networks
MLP Multilayer Perceptron
NB NodeB
PCS Personal Communications Services
PnP Perspective-n-Point
RANSAC Random Sample Consensus
RNN Recurrent Neuronal Network
SfM Structure from Motion
SLAM Simultaneous Localization and Mapping
TISPAN Telecoms & Internet converged Services & Protocols for Advanced Networks
UE User Equipment
UMTS Universal Mobile Telecommunications System
UWB Ultra-Wideband
WCDMA Wideband Code Division Multiple Access
WiMAX Worldwide Interoperability for Microwave Access
WLAN Wireless Local Area Network

### SUMMARY

Various exemplary embodiments of the present disclosure aim at addressing at least part of the above issues and/or problems and drawbacks.

Various aspects of exemplary embodiments of the present disclosure are set out in the appended claims.

According to an example of an embodiment, there is provided, for example, an apparatus comprising an apparatus, comprising at least one processing circuitry, and at least one memory for storing instructions to be executed by the processing circuitry. The at least one memory and the instructions are configured to, with the at least one processing circuitry, cause the apparatus at least to input display data obtained from a first terminal endpoint device located in a first three-dimensional environment into a deep neural network model for terminal endpoint device pose estimation. The display data comprising at least image data and sensory data. Image data of a captured image of at least part of the first three-dimensional environment acquired by the first terminal endpoint device at a first point of time. Sensory data indicative of at least a motion vector of a movement of the first terminal endpoint device in the three-dimensional environment acquired by the first terminal endpoint device at a second point of time. The deep neural network model being trained with, as model input, training image data and training sensory data. Training image data of a captured training image of at least part of a three-dimensional training environment acquired by a training terminal endpoint device located in the three-dimensional training environment. Training sensory data indicative of at least a motion vector of a movement of the training terminal endpoint device in the three-dimensional training environment. The deep neural network model being trained with, as model output, training poses of the training terminal endpoint device in the three-dimensional training environment. Additionally, the apparatus is further caused to obtain from the deep neural network model for terminal endpoint device pose estimation, based on the input display data, a first estimated pose of the first terminal endpoint device in the first three-dimensional environment.

In addition, according to an example of an embodiment, there is provided, for example, a method comprising the steps of inputting display data obtained from a first terminal endpoint device located in a first three-dimensional environment into a deep neural network model for terminal endpoint device pose estimation. The display data comprising at least image data and sensory data. Image data of a captured image of at least part of the first three-dimensional environment acquired by the first terminal endpoint device at a first point of time. Sensory data indicative of at least a motion vector of a movement of the first terminal endpoint device in the three-dimensional environment acquired by the first terminal endpoint device at a second point of time. The deep neural network model being trained with, as model input, training image data and training sensory data. Training image data of a captured training image of at least part of a three-dimensional training environment acquired by a training terminal endpoint device located in the three-dimensional training environment. Training sensory data indicative of at least a motion vector of a movement of the training terminal endpoint device in the three-dimensional training environment. The deep neural network model being trained with, as model output, training poses of the training terminal endpoint device in the three-dimensional training environment. Additionally, the method further comprises the steps of obtaining from the deep neural network model for terminal endpoint device pose estimation, based on the input display data, a first estimated pose of the first terminal endpoint device in the first three-dimensional environment.

According to further refinements, these examples may include one or more of the following features:
Optionally, the first point of time is equal to the second point of time;
Furthermore, the at least one memory and the instructions may further be configured to cause the apparatus at least to add to the display data a previous estimated pose of the first terminal endpoint device in the first three-dimensional environment obtained from the deep neural network model previous to the first estimated pose, and the deep neural network model being further trained with previous output training poses of the training terminal endpoint device as model input;
Moreover, the at least one memory and the instructions may further be configured to cause the apparatus at least to add to the display data previous image data and previous sensory data. Wherein the previous image data being image data of a previous captured image of at least part of the first three-dimensional environment acquired by the first terminal endpoint device at a third point of time previous to the first point of time. Wherein the previous sensory data being sensory data indicative of at least a motion vector of a previous movement of the first terminal endpoint device in the three-dimensional environment acquired by the first terminal endpoint device at a fourth point of time previous to the second point of time. And the deep neural network model being further trained with previous image data and previous sensory data as model input;
Furthermore, the third point of time may be equal to the fourth point of time;
Further, the sensory data may comprise at least data acquired from at least one of an accelerometer, a gyroscope, a magnetometer, and a fusion sensor;
Optionally, the training terminal endpoint device is a second terminal endpoint device;
Alternatively, the training terminal endpoint device is a computer simulated terminal endpoint device and the three-dimensional training environment is a computer simulated three-dimensional training environment;
Additionally, in case of the three-dimensional training environment being different from the first three-dimensional environment, the deep neural network model is used for terminal endpoint device pose estimation in the first three-dimensional environment through transfer learning of the first three-dimensional environment from the three-dimensional training environment;
Moreover, the at least one memory and the instructions may further be configured to cause the apparatus at least to project, based on the first estimated pose of the first terminal endpoint device in the first three-dimensional environment, three-dimensional virtual network information onto the captured image. In addition, the apparatus is caused to generate an augmented reality output image by overlaying the three-dimensional virtual network information with the captured image;
Furthermore, the at least one memory and the instructions may further be configured to cause the apparatus at least to project the three-dimensional virtual network information onto the captured image further based on a three-dimensional virtual network information model for the first three-dimensional environment comprising the three-dimensional virtual network information. Wherein a field of view generated for the three-dimensional virtual network information is configured to be the same as a field of view captured by the captured image;
Optionally, the three-dimensional virtual network information model is provided to the apparatus;
Alternatively, the three-dimensional virtual network information model is learned by the apparatus from at least part of the display data using 3D environment reconstruction techniques;
Further alternatively, the three-dimensional virtual network information model is learned by the apparatus through transfer learning from a pre-learned three-dimensional virtual network information model for a second three-dimensional environment different from the first three-dimensional environment;
Moreover, the deep neural network model may comprise the three-dimensional virtual network information model;
Furthermore, the three-dimensional virtual network information for the first three-dimensional environment may be obtained from measurements of network performance indicators of a radio network in the first three-dimensional environment;
Optionally, the three-dimensional virtual network information for the first three-dimensional environment are computer simulated network performance indicators of a computer simulated radio network in the first three-dimensional environment;
Further, the three-dimensional virtual network information may be three-dimensional radio map information indicative of radio network performance;
Additionally, the apparatus may be configured to be integrated in the first terminal endpoint device, wherein the deep neural network model is maintained at the first terminal endpoint device, or the apparatus may be configured to be integrated in a network communication element, wherein the deep neural network model is maintained at the network communication element;
Moreover, the captured image may be a two-dimensional image captured by a monocular camera, or a stereo image comprising depth information captured by a stereoscopic camera unit, or a thermal image captured by a thermographic camera.

Furthermore, according to an example of an embodiment, there is provided, for example, an apparatus configured for being connected to at least one camera unit and to at least one sensor unit. The apparatus, comprising at least one processing circuitry, and at least one memory for storing instructions to be executed by the processing circuitry, wherein the at least one memory and the instructions are configured to, with the at least one processing circuitry, cause the apparatus at least to provide display data. The display data comprising at least image data and sensory data. The image data of a captured image of at least part of a three-dimensional environment surrounding the apparatus captured by the at least one camera unit at a first point of time. The sensory data indicative of at least a motion vector of a movement of the apparatus in the three-dimensional environment acquired by the at least one sensor unit at a second point of time. The apparatus is further caused to display, based on the provided display data, network information associated with a first estimated pose of the apparatus in the three-dimensional environment overlaid with the captured image.

In addition, according to an example of an embodiment, there is provided, for example, a method comprising the steps of providing display data. The display data comprising at least image data and sensory data. The image data of a captured image of at least part of a three-dimensional environment surrounding an apparatus captured by a camera unit configured to be connected to the apparatus at a first point of time. The sensory data indicative of at least a motion vector of a movement of the apparatus in the three-dimensional environment acquired by a sensor unit configured to be connected to the apparatus at a second point of time. The method further comprises the steps of displaying, based on the provided display data, network information associated with a first estimated pose of the apparatus in the three-dimensional environment overlaid with the captured image.

According to further refinements, these examples may include one or more of the following features:
Optionally, the first point of time is equal to the second point of time;
Moreover, the displayed network information may comprise an augmented reality image generated by overlaying three-dimensional virtual network information with the captured image;
In addition, the three-dimensional virtual network information may be three-dimensional radio map information being configured for AR-supported network service;
Furthermore, the at least one sensor unit may be at least one of an accelerometer, a gyroscope, a magnetometer, and a fusion sensor;
Further, the at least one camera unit may comprise at least one of a monocular camera, a stereoscopic camera unit, and a thermographic camera.

In addition, according to embodiments, there is provided, for example, a computer program product for a computer, including software code portions for performing the steps of the above defined methods, when said product is run on the computer. The computer program product may include a computer-readable medium on which said software code portions are stored. Furthermore, the computer program product may be directly loadable into the internal memory of the computer and/or transmittable via a network by means of at least one of upload, download and push procedures.

Any one of the above aspects enables camera relocalization for real-time AR-supported network service visualization thereby solving at least part of the problems and drawbacks identified in relation to the prior art.

Thus, improvement is achieved by apparatuses, methods, and computer program products enabling camera relocalization for real-time AR-supported network service visualization.

### BRIEF DESCRIPTION OF THE DRAWINGS

Some embodiments of the present disclosure are described below, by way of example only, with reference to the accompanying drawings, in which:

FIG. 1 shows an example according to examples of embodiments of interactive augmented reality (AR)-enabled interface for network planning service;

FIG. 2A shows a deep neural network (DNN) of PoseNet based on GoogLeNet proposed in [KC+17];

FIG. 2B (part 1 and part 2) shows an enlarged view of the deep neural network (DNN) of PoseNet based on GoogLeNet according to FIG. 2A;

FIG. 3 shows a flow chart illustrating steps corresponding to a method according to examples of embodiments;

FIG. 4 shows a flow chart illustrating steps corresponding to a method according to examples of embodiments;

FIG. 5 shows a block diagram illustrating an apparatus according to examples of embodiments;

FIG. 6 shows a block diagram illustrating an apparatus according to examples of embodiments;

FIG. 7A shows an example of a DNN according to examples of embodiments with additional architecture features, fusing image and inertial measurement units (IMU) data as inputs of the DNN;

FIG. 7B (part 1 and part 2) shows an enlarged view of the example of the DNN according to FIG. 7A;

FIG. 8 shows an example of a DNN according to examples of embodiments with additional architecture features, fusing image, IMU data, and previous pose state as inputs of the DNN;

FIG. 9 shows a process according to examples of embodiments of AR-supported network service visualization;

FIG. 10 shows a step of model training according to examples of embodiments;

FIG. 11 shows a data flow of the MapNet family including MapNet, MapNet+, and MapNet+PGO [BGK+18];

FIG. 12 shows an example of the proposed DNN according to examples of embodiments, adding sensory features to a convolutional neural network (CNN);

FIG. 13A shows an example of ResNet with additional architecture features according to examples of embodiments, fusing image and sensor (e.g., IMU) data as inputs of the DNN;

FIG. 13B shows an enlarged view of the example of ResNet according to FIG. 13A;

FIG. 14 (part 1 and part 2) shows an example of GoogLeNet with additional architecture features according to examples of embodiments, fusing image and sensor (e.g., IMU) data as inputs of the DNN;

FIG. 15 shows an example of projecting radio map on a user device's display according to examples of embodiments;

FIG. 16 shows a recurrent structure of a DNN according to examples of embodiments, taking previous N states of estimated camera pose into account;

FIG. 17 shows an alternative recurrent neuronal network (RNN) architecture according to examples of embodiments;

FIG. 18 shows transfer learning from one environment to another according to examples of embodiments; and

FIG. 19 shows a process of adapting a pre-trained DNN for camera pose estimation to a new environment using transfer learning according to examples of embodiments.

### DESCRIPTION OF EMBODIMENTS

In the last years, an increasing extension of communication networks, e.g. of wire based communication networks, such as the Integrated Services Digital Network (ISDN), Digital Subscriber Line (DSL), or wireless communication networks, such as the cdma2000 (code division multiple access) system, cellular 3rd generation (3G) like the Universal Mobile Telecommunications System (UMTS), fourth generation (4G) communication networks or enhanced communication networks based e.g. on Long Term Evolution (LTE) or Long Term Evolution-Advanced (LTE-A), fifth generation (5G) communication networks, cellular 2nd generation (2G) communication networks like the Global System for Mobile communications (GSM), the General Packet Radio System (GPRS), the Enhanced Data Rates for Global Evolution (EDGE), or other wireless communication system, such as the Wireless Local Area Network (WLAN), Bluetooth or Worldwide Interoperability for Microwave Access (WiMAX), took place all over the world. Various organizations, such as the European Telecommunications Standards Institute (ETSI), the 3rd Generation Partnership Project (3GPP), Telecoms & Internet converged Services & Protocols for Advanced Networks (TISPAN), the International Telecommunication Union (ITU), 3rd Generation Partnership Project 2 (3GPP2), Internet Engineering Task Force (IETF), the IEEE (Institute of Electrical and Electronics Engineers), the WiMAX Forum and the like are working on standards or specifications for telecommunication network and access environments.

Basically, for properly establishing and handling a communication between two or more end points (e.g. communication stations or elements or functions, such as terminal devices, user equipments (UEs), or other communication network elements, a database, a server, host etc.), one or more network elements or functions (e.g. virtualized network functions), such as communication network control elements or functions, for example access network elements like access points, radio base stations, relay stations, eNBs, gNBs etc., and core network elements or functions, for example control nodes, support nodes, service nodes, gateways, user plane functions, access and mobility functions etc., may be involved, which may belong to one communication network system or different communication network systems.

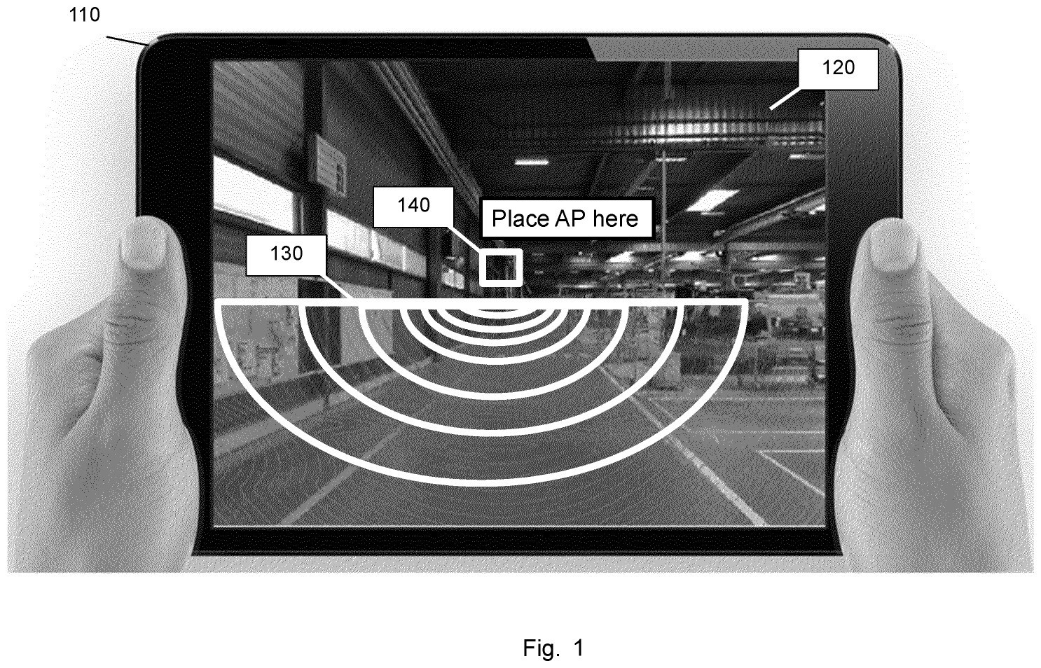

In view of different types of communication, the conventional network service offers offline unidirectional communication between the customer and service provider. For example, many network planning tools require users to manually upload building plan or geographical maps, and, based on the uploaded data, they provide simple visualization features, such as two-dimensional (2D) view of the radio map. To enable a zero-touch network service with better use experience, it is disclosed herein an online interactive service interface that is automatically environment-aware and can visualize network performance with augmented reality (AR) in real-time [LS+18]. FIG. 1 shows an example of AR-enabled interactive interface for radio network planning. Specifically, an image of an indoor area 120 displayed on a handheld display device 110 is shown in FIG. 1, wherein virtual network information, highlighted in bolt semicircles 130, indicating a location 140 in the indoor area 120 to place an access point (AP) are overlaid the image of the indoor area 120. As shown in FIG. 1, because augmented scenes are generally computed by projecting virtual information (e.g., 3D objects, radio maps, instructions) onto 2D image with a device-perspective view, one of the main technical challenges is to estimate camera pose (including both 3D position and orientation) in real-time.

As outlined above, camera pose estimation can be classified into two types of problems, wherein it is an object of the present specification to provide a solution to the second type of the pose estimation problems, camera relocalization, i.e., estimating camera pose in real-time by exploiting fused sensory data and previously learned mapping and localization data in the same or similar environment.

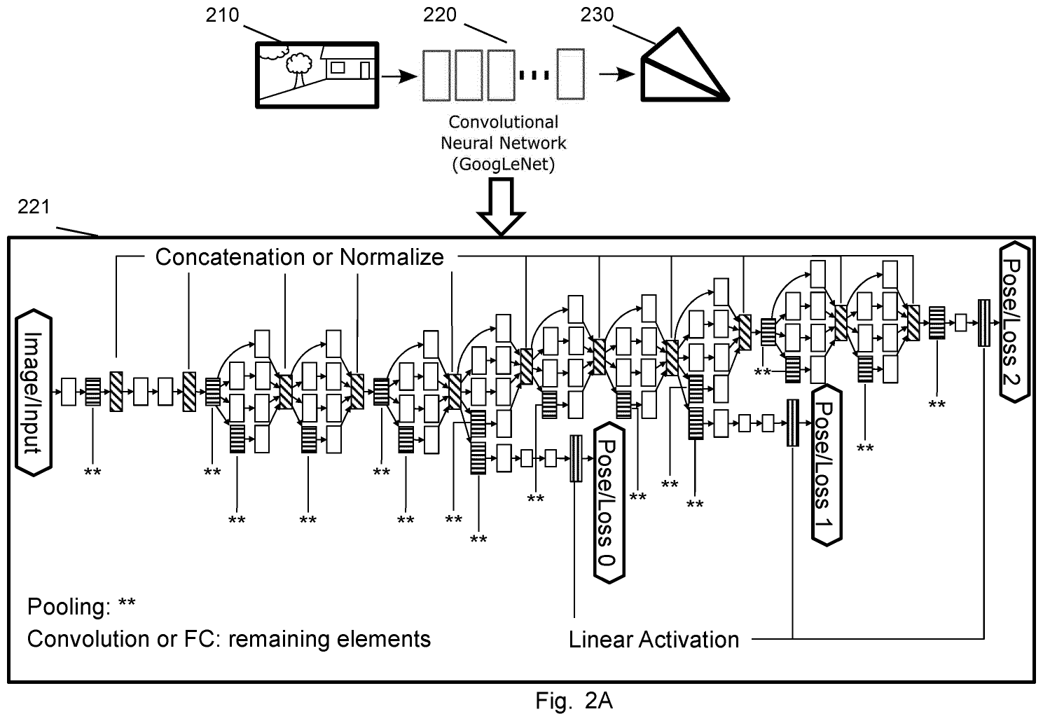

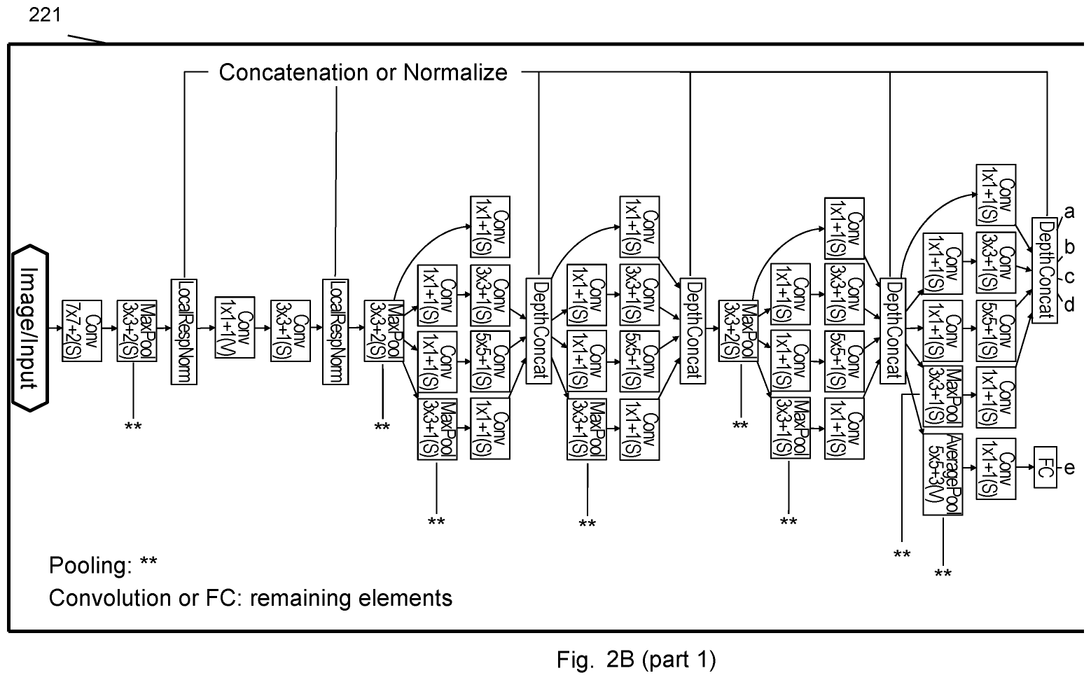

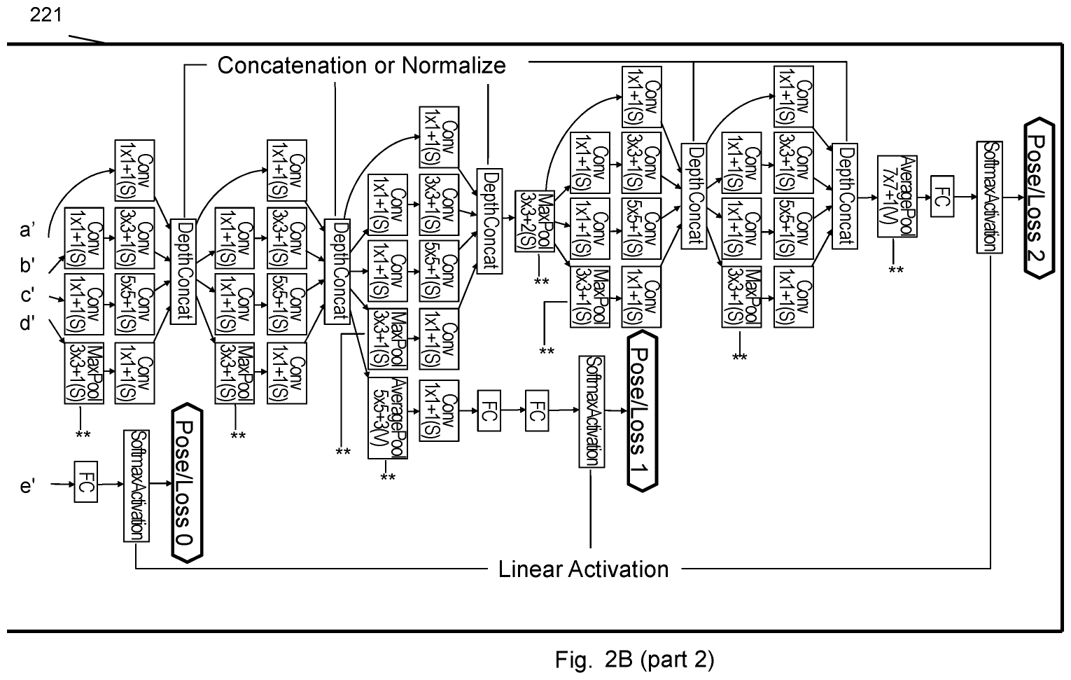

The conventional camera relocalization methods estimate the 6 degree-of-freedom (DoF) camera pose by using visual odometry techniques. For example, in [JDV+13] the 2D-to-3D point correspondences are obtained from the inherent relationship between the real camera's 2D features and their matches on the virtual image (created by projecting the map points in prior map onto a plane using the previously localized pose of the real camera). Then, the well-known perspective-n-point (PnP) problem is solved to find the relative pose between the real and the virtual cameras. The projection error is minimized by using random sample consensus (RANSAC). However, because such visual odometry-based method iteratively minimizes the estimation error over image frames, the performance may converge slowly (if it ever converges), and it is very sensitive to fast scene changing. To realize real-time camera relocalization for enabling AR features, a new method called “PoseNet” based on the deep learning is introduced in [KC+17]. A direct mapping relationship between a single image and its corresponding camera pose is represented by a deep neural network (DNN) (as shown in FIGS. 2A, 2B). Specifically, according to FIG. 2A, input of a RGB image 210 into a convolutional neural network 220 (comprising a structure 221 as indicated at the lower part of FIG. 2) in order to obtain a 6-DoF camera pose 230 is illustrated. FIG. 2B (part 1 and part 2; connecting a to a′, b to b′, c to c′, d to d′, and e to e′) shows an enlarged view of the structure 221 according to FIG. 2A.

The recent work [BGK+18] proposes “MapNet” to add sensory data such as inertial measurement unit (IMU) measures to enhance the model, whereas IMU data is only used to modify the loss function, forming extra constraints on camera movement implied by IMU measures. The input (image) and the output (camera pose) of the DNN remain unchanged. Thus, the above-mentioned methods do not fully exploit the information of device motion provided by IMU and other sensors.

In the following, different exemplifying embodiments will be described using, as an example of a communication network to which examples of embodiments may be applied, a communication network architecture based on 3GPP standards for a communication network, such as a 5G/NR, without restricting the embodiments to such an architecture, however. It is obvious for a person skilled in the art that the embodiments may also be applied to other kinds of communication networks where mobile communication principles are integrated, e.g. Wi-Fi, worldwide interoperability for microwave access (WiMAX), Bluetooth®, personal communications services (PCS), ZigBee®, wideband code division multiple access (WCDMA), systems using ultra-wideband (UWB) technology, mobile ad-hoc networks (MANETs), wired access, etc. Furthermore, without loss of generality, the description of some examples of embodiments is related to a mobile communication network, but principles of the disclosure can be extended and applied to any other type of communication network, such as a wired communication network.

The following examples and embodiments are to be understood only as illustrative examples. Although the specification may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also contain features, structures, units, modules etc. that have not been specifically mentioned.

A basic system architecture of a (tele)communication network including a mobile communication system where some examples of embodiments are applicable may include an architecture of one or more communication networks including wireless access network subsystem(s) and core network(s). Such an architecture may include one or more communication network control elements or functions, access network elements, radio access network elements, access service network gateways or base transceiver stations, such as a base station (BS), an access point (AP), a NodeB (NB), an eNB or a gNB, a distributed or a centralized unit, which controls a respective coverage area or cell(s) and with which one or more communication stations such as communication elements or functions, like user devices or terminal devices, like a UE, or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels via one or more communication beams for transmitting several types of data in a plurality of access domains. Furthermore, core network elements or network functions, such as gateway network elements/functions, mobility management entities, a mobile switching center, servers, databases and the like may be included.

The general functions and interconnections of the described elements and functions, which also depend on the actual network type, are known to those skilled in the art and described in corresponding specifications, so that a detailed description thereof is omitted herein. However, it is to be noted that several additional network elements and signaling links may be employed for a communication to or from an element, function or application, like a communication endpoint, a communication network control element, such as a server, a gateway, a radio network controller, and other elements of the same or other communication networks besides those described in detail herein below.

A communication network architecture as being considered in examples of embodiments may also be able to communicate with other networks, such as a public switched telephone network or the Internet. The communication network may also be able to support the usage of cloud services for virtual network elements or functions thereof, wherein it is to be noted that the virtual network part of the telecommunication network can also be provided by non-cloud resources, e.g. an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g., a cloud infrastructure.

Furthermore, a network element, such as communication elements, like a UE, a terminal device, control elements or functions, such as access network elements, like a base station (BS), an gNB, a radio network controller, a core network control element or function, such as a gateway element, or other network elements or functions, as described herein, and any other elements, functions or applications may be implemented by software, e.g. by a computer program product for a computer, and/or by hardware. For executing their respective processing, correspondingly used devices, nodes, functions or network elements may include several means, modules, units, components, etc. (not shown) which are required for control, processing and/or communication/signaling functionality. Such means, modules, units and components may include, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means including e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors.

It should be appreciated that according to some examples, a so-called “liquid” or flexible network concept may be employed where the operations and functionalities of a network element, a network function, or of another entity of the network, may be performed in different entities or functions, such as in a node, host or server, in a flexible manner. In other words, a “division of labor” between involved network elements, functions or entities may vary case by case.

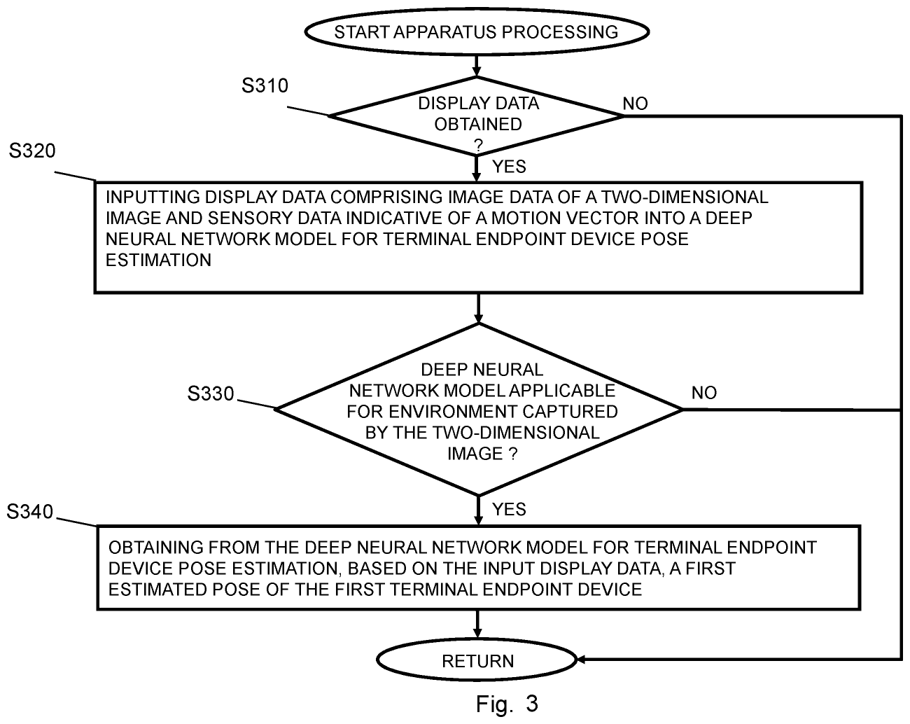

Referring now to FIG. 3, there is shown a flow chart illustrating steps corresponding to a method according to examples of embodiments.

In particular, according to FIG. 3, if display data are obtained (S310: YES), in S320, the display data obtained from a first terminal endpoint device located in a first three-dimensional environment are input into a deep neural network model for terminal endpoint device pose estimation. In case of no display data are obtained (S310: NO), no further processing is performed. Specifically, the display data comprise at least image data and sensory data. Image data of a captured image of at least part of the first three-dimensional environment acquired by the first terminal endpoint device at a first point of time. And sensory data indicative of at least a motion vector of a movement of the first terminal endpoint device in the three-dimensional environment acquired by the first terminal endpoint device at a second point of time. Additionally, the deep neural network model being trained with, as model input, training image data and training sensory data. Training image data of a captured training image of at least part of a three-dimensional training environment acquired by a training terminal endpoint device located in the three-dimensional training environment. And training sensory data indicative of at least a motion vector of a movement of the training terminal endpoint device in the three-dimensional training environment. The deep neural network model being additionally trained with, as model output, training poses of the training terminal endpoint device in the three-dimensional training environment. Further, in case the deep neural network model is applicable for the environment captured by the captured image (S330: YES), in S340, a first estimated pose of the first terminal endpoint device is obtained from the deep neural network model for terminal endpoint device pose estimation, based on the input display data.

According to various examples of embodiments, the first point of time may be equal to the second point of time.

Furthermore, according to at least some examples of embodiments, the method may further comprise the steps of adding to the display data a previous estimated pose of the first terminal endpoint device in the first three-dimensional environment obtained from the deep neural network model previous to the first estimated pose. In addition, the deep neural network model being further trained with previous output training poses of the training terminal endpoint device as model input.

Moreover, according to various examples of embodiments, the method may further comprise the steps of adding to the display data previous image data and previous sensory data. The previous image data being image data of a previous captured image of at least part of the first three-dimensional environment acquired by the first terminal endpoint device at a third point of time previous to the first point of time. The previous sensory data being sensory data indicative of at least a motion vector of a previous movement of the first terminal endpoint device in the three-dimensional environment acquired by the first terminal endpoint device at a fourth point of time previous to the second point of time. The deep neural network model being further trained with previous image data and previous sensory data as model input.

Optionally, according to various examples of embodiments, the third point of time is equal to the fourth point of time.

Further, according to at least some examples of embodiments, the sensory data may comprise at least data acquired from at least one of an accelerometer, a gyroscope, a magnetometer, and a fusion sensor.

Moreover, according to various examples of embodiments, the training terminal endpoint device may be a second terminal endpoint device.

Alternatively, according to various examples of embodiments, the training terminal endpoint device is a computer simulated terminal endpoint device and the three-dimensional training environment is a computer simulated three-dimensional training environment.

Optionally, according to at least some examples of embodiments, in case of the three-dimensional training environment being different from the first three-dimensional environment, the deep neural network model is used for terminal endpoint device pose estimation in the first three-dimensional environment through transfer learning of the first three-dimensional environment from the three-dimensional training environment.

Furthermore, according to at least some examples of embodiments, the method may further comprise the steps of projecting, based on the first estimated pose of the first terminal endpoint device in the first three-dimensional environment, three-dimensional virtual network information onto the captured image. In addition, the method comprises the steps of generating an augmented reality output image by overlaying the three-dimensional virtual network information with the captured image.

Furthermore, according to various examples of embodiments, the method may further comprise the steps of projecting the three-dimensional virtual network information onto the captured image further based on a three-dimensional virtual network information model for the first three-dimensional environment comprising the three-dimensional virtual network information. Wherein a field of view generated for the three-dimensional virtual network information is configured to be the same as a field of view captured by the captured image.

Additionally, according to at least some examples of embodiments, the three-dimensional virtual network information model may be provided to an apparatus applying the method.

Alternatively, according to at least some examples of embodiments, the three-dimensional virtual network information model is learned by an apparatus applying the method from at least part of the display data using 3D environment reconstruction techniques.

Further alternatively, according to various examples of embodiments, the three-dimensional virtual network information model is learned by an apparatus applying the method through transfer learning from a pre-learned three-dimensional virtual network information model for a second three-dimensional environment different from the first three-dimensional environment.

Optionally, according to at least some examples of embodiments, the deep neural network model comprises the three-dimensional virtual network information model.

Moreover, according to various examples of embodiments, the three-dimensional virtual network information for the first three-dimensional environment may be obtained from measurements of network performance indicators of a radio network in the first three-dimensional environment.

Furthermore, according to at least some examples of embodiments, the three-dimensional virtual network information for the first three-dimensional environment may be computer simulated network performance indicators of a computer simulated radio network in the first three-dimensional environment.

Optionally, according to various examples of embodiments, the three-dimensional virtual network information are three-dimensional radio map information indicative of radio network performance.

Further, according to various examples of embodiments, the method may be configured to be applied by an apparatus configured to be integrated in the first terminal endpoint device, wherein the deep neural network model is maintained at the first terminal endpoint device, or the method may be configured to be applied by an apparatus configured to be integrated in a network communication element, wherein the deep neural network model is maintained at the network communication element.

Moreover, according to at least some examples of embodiments, the captured image is a two-dimensional image captured by a monocular camera, or a stereo image comprising depth information captured by a stereoscopic camera unit, or a thermal image captured by a thermographic camera.

The above mentioned features, either alone or in combination, allow for camera relocalization for real-time AR-supported network service visualization. In this context, the above mentioned features, either alone or in combination, specifically allow, due to using the display data comprising at least image data and sensory data, to obtain more accurate and direct information about a camera's orientation and moving direction as compared with prior art methods.

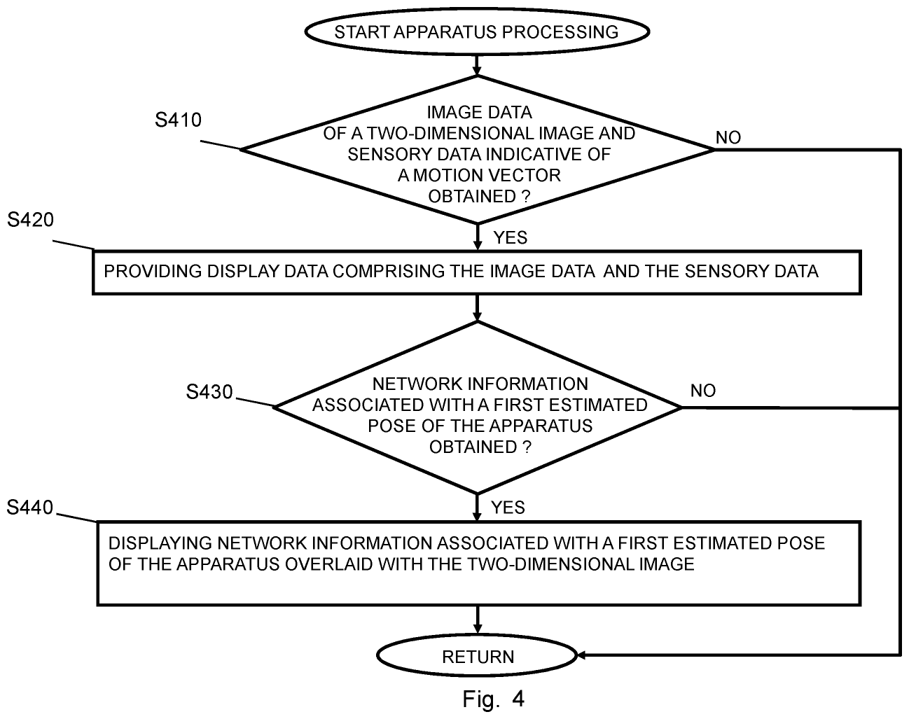

Referring now to FIG. 4, there is shown a flow chart illustrating steps corresponding to a method according to examples of embodiments.

In particular, according to FIG. 4, in case image data of a captured image and sensory data indicative of a motion vector are obtained (S410: YES), in S420, display data comprising at least the image data and the sensory data are provided. Specifically, image data of a captured image of at least part of a three-dimensional environment surrounding an apparatus captured by a camera unit configured to be connected to the apparatus at a first point of time. And sensory data indicative of at least a motion vector of a movement of the apparatus in the three-dimensional environment acquired by a sensor unit configured to be connected to the apparatus at a second point of time. In case of no display data are obtained (S410: NO), no further processing is performed. Further, in case network information associated with a first estimated pose of the apparatus are obtained (S430: YES), in S440, based on the provided display data, network information associated with a first estimated pose of the apparatus in the three-dimensional environment overlaid with the captured image are displayed. In case of no network information associated with a first estimated pose of the apparatus are obtained (S430: NO), no further processing is performed.

According to various examples of embodiments, the first point of time may be equal to the second point of time.

Furthermore, according to at least some examples of embodiments, the displayed network information may comprise an augmented reality image generated by overlaying three-dimensional virtual network information with the captured image.

Moreover, according to various examples of embodiments, the three-dimensional virtual network information may be three-dimensional radio map information being configured for AR-supported network service.

Optionally, according to at least some examples of embodiments, the sensor unit is at least one of an accelerometer, a gyroscope, a magnetometer, and a fusion sensor.

Further, according to various examples of embodiments, the camera unit may comprise at least one of a monocular camera, a stereoscopic camera unit, and a thermographic camera. Further, the principles outlined in relation to at least some examples of embodiments are also applicable to ultrasonic sound images captured by a corresponding sound emitter/detector arrangement.

The above mentioned features, either alone or in combination, allow for camera relocalization for real-time AR-supported network service visualization. In this context, the above mentioned features, either alone or in combination, specifically allow, due to providing the display data comprising at least image data and sensory data, to obtain more accurate and direct information about a camera's orientation and moving direction as compared with prior art methods.

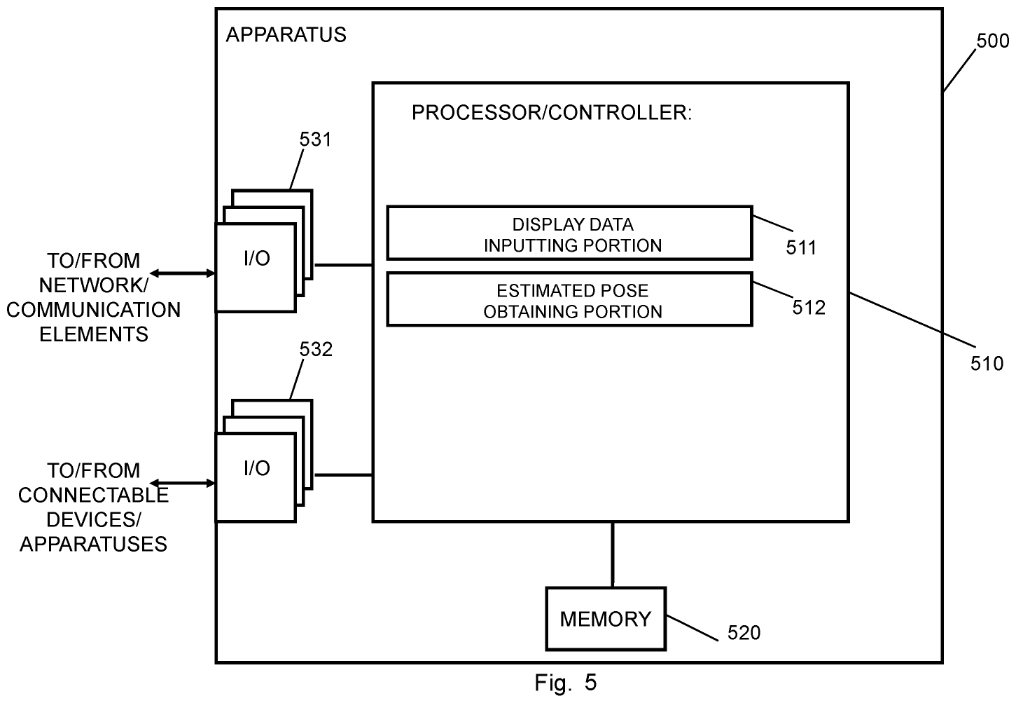

Referring now to FIG. 5, FIG. 5 shows a block diagram illustrating an apparatus 500. The apparatus 500 e.g. being configured to be applied in a network communication element, like e.g. in a cloud server, or the apparatus 500 e.g. being configured to be applied in a terminal endpoint device, like e.g. a user equipment. The apparatus 500 may further be configured to communicate with e.g. a DNN, specifically to input data into the DNN and to receive, as an output, a result thereof from the DNN according to examples of embodiments. It is to be noted that the apparatus 500 may include further elements or functions besides those described herein below. Furthermore, even though reference is made to an apparatus, the element or function may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The apparatus 500 shown in FIG. 5 may include a processing circuitry, a processing function, a control unit or a processor 510, such as a CPU or the like, which is suitable to input display data into another device/entity/program and to obtain an estimated pose in relation to the input display data. The processor 510 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference signs 531, 532 denote input/output (I/O) units or functions (interfaces) connected to the processor or processing function 510. The I/O units 531, 532 may be used for communicating with network elements/communication elements and/or connectable devices/apparatuses. Reference sign 520 denotes a memory usable, for example, for storing data and programs to be executed by the processor or processing function 510 and/or as a working storage of the processor or processing function 510. It is to be noted that the memory 520 may be implemented by using one or more memory portions of the same or different type of memory. In addition, the memory 520 may refer to a database, e.g. a cloud server based database. Thus the memory 520 may be connected/linked to the apparatus 500, but not comprised by the apparatus 500.

The processor or processing function 510 is configured to execute processing related to the above described method. In particular, the processor or processing circuitry or function 510 includes one or more of the following sub-portions. Sub-portion 511 is a processing portion which is usable as a portion for inputting display data. The portion 511 may be configured to perform processing according to S320 of FIG. 3. Furthermore, the processor or processing circuitry or function 510 may include a sub-portion 512 usable as a portion for obtaining an estimated pose. The portion 512 may be configured to perform a processing according to S340 of FIG. 3.

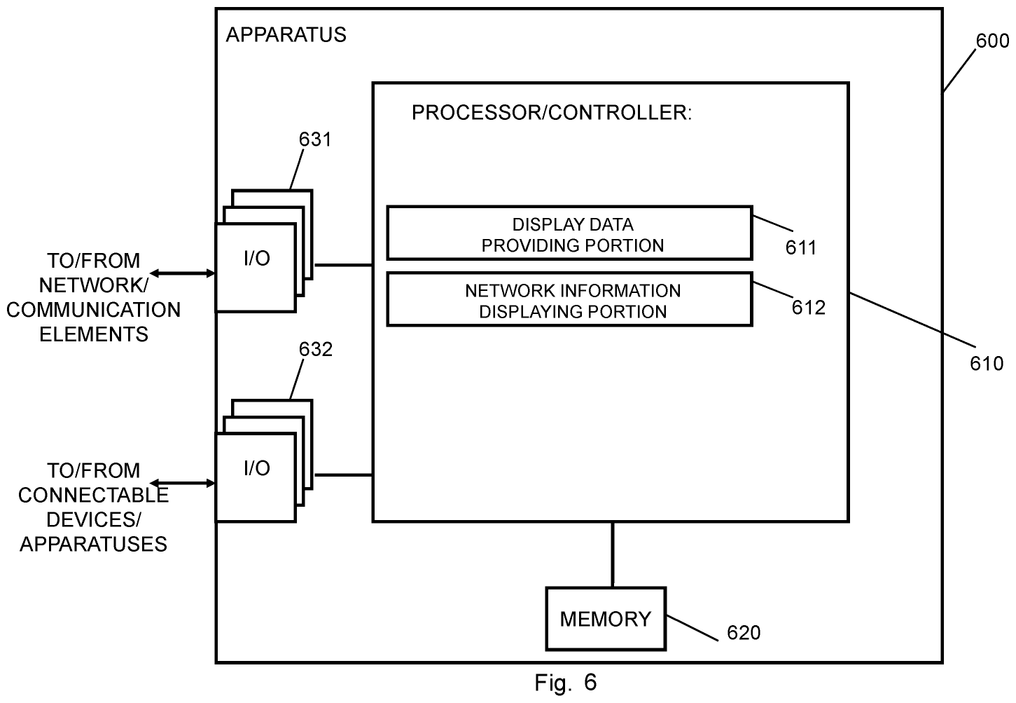

Referring now to FIG. 6, FIG. 6 shows a block diagram illustrating an apparatus 600. The apparatus 600 e.g. being configured to be applied in a terminal endpoint device, like e.g. a user equipment. The apparatus 600 may further be configured to acquire display data e.g. image data from images captured by a camera unit and/or sensory data recovered from a sensor unit according to examples of embodiments. It is to be noted that the apparatus 600 may include further elements or functions besides those described herein below. Furthermore, even though reference is made to an apparatus, the element or function may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The apparatus 600 shown in FIG. 6 may include a processing circuitry, a processing function, a control unit or a processor 610, such as a CPU or the like, which is suitable to provide display data to another device/entity/program and to display received network information. The processor 610 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference signs 631, 632 denote input/output (I/O) units or functions (interfaces) connected to the processor or processing function 610. The I/O units 631, 632 may be used for communicating with network elements/communication elements and/or connectable devices/apparatuses. Reference sign 620 denotes a memory usable, for example, for storing data and programs to be executed by the processor or processing function 610 and/or as a working storage of the processor or processing function 610. It is to be noted that the memory 620 may be implemented by using one or more memory portions of the same or different type of memory.

The processor or processing function 610 is configured to execute processing related to the above described method. In particular, the processor or processing circuitry or function 610 includes one or more of the following sub-portions. Sub-portion 611 is a processing portion which is usable as a portion for providing display data. The portion 611 may be configured to perform processing according to S420 of FIG. 4. Furthermore, the processor or processing circuitry or function 610 may include a sub-portion 612 usable as a portion for displaying network information. The portion 612 may be configured to perform a processing according to S440 of FIG. 4.

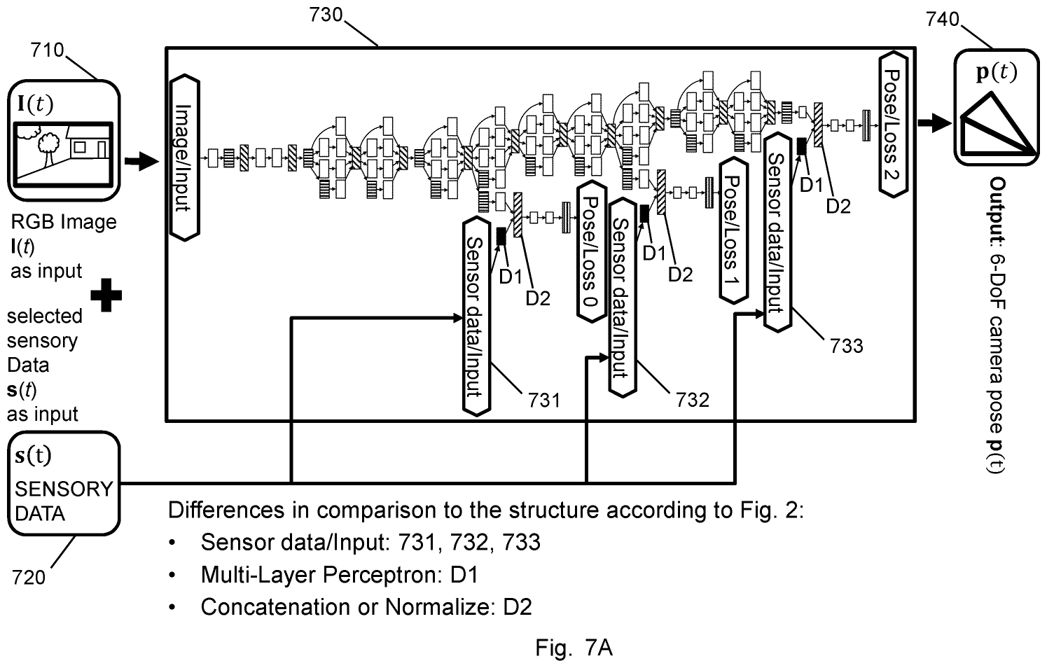

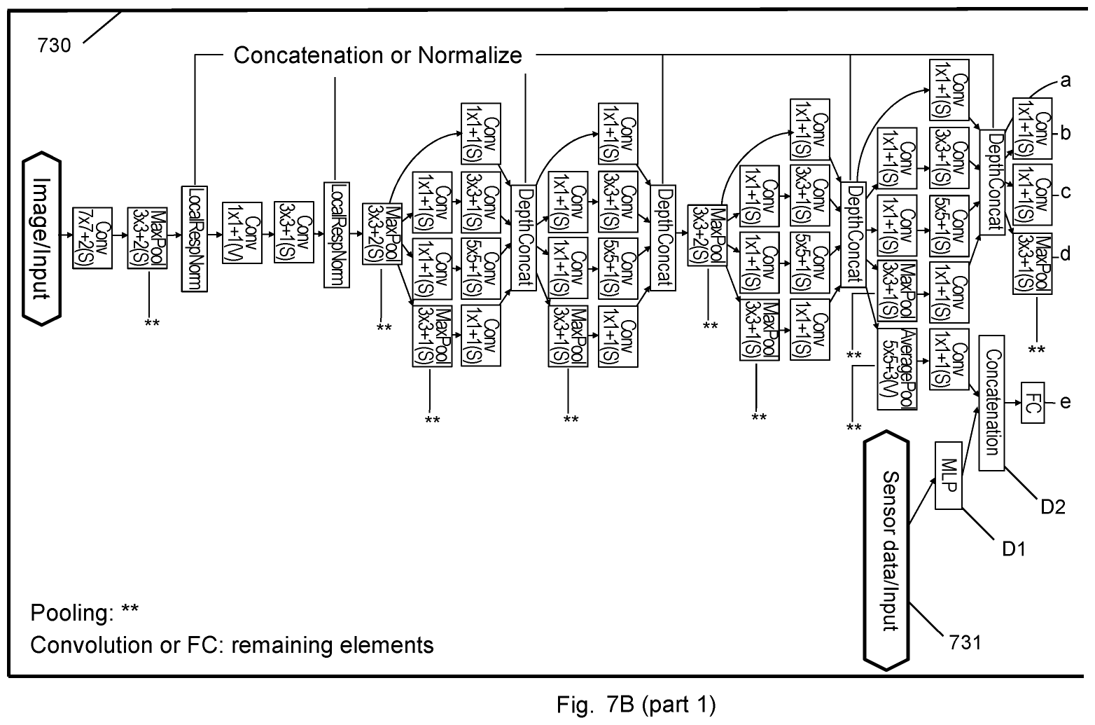

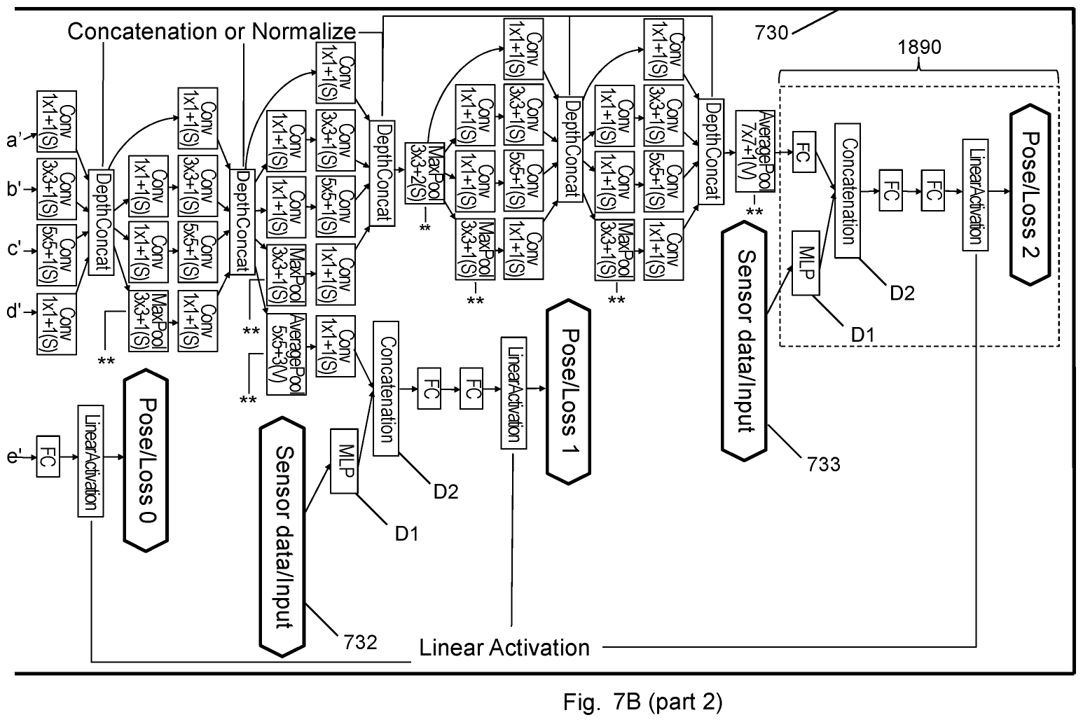

In the following, further details and implementation examples according to examples of embodiments are described with reference to FIGS. 7 to 19.

One idea of the present specification regarding cameral relocalization is to estimate camera pose using a DNN with fused image data and other sensory data (such as IMU measures) as the inputs of the DNN. Compared to [BGK+18], where IMU measurements are used in the design of the loss function while the single image input remains unchanged as in [KC+17], the method according to the present specification directly adds sensory data into the DNN inputs for better utilization of the motion sensor data. Fusing image and other sensory data as combined inputs to DNN also leads to the change of the DNN architecture, i.e., adding extra architecture features to the intermediate layers to read the sensory information.

The difference between the two approaches can be easily recognized by comparing the examples given in FIGS. 2A and 2B and FIGS. 7A and 7B (differences in the DNN structure 730 according to FIG. 7A in comparison to the DNN structure 221 according to FIG. 2A are highlighted/named in FIG. 7A). FIG. 7A shows an example of a DNN 730 according to examples of embodiments with additional architecture features, sensor data inputs 731, 732, 733 (wherein the sensor data inputs 731, 732, 733 are respectively connected to a Multi-Layer Perceptron-element D1, which is respectively connected to a Concatenation or Normalize-element D2) specifically, thereby fusing image data of an RGB input image 710 and inertial measurement units (IMU) data (e.g. sensory data) 720 as inputs of the DNN 730. A 6-DoF camera pose 740 is obtained thereof. FIG. 7B (part 1 and part 2; connecting a to a′, b to b′, c to c′, d to d′, and e to e′) shows an enlarged view of the DNN structure 730 according to FIG. 7A.

Because the camera pose is highly temporal dependent, adding as extra input(s) the previous state(s) of camera pose to capture the temporal dependency is further outlined in the specification herein below.

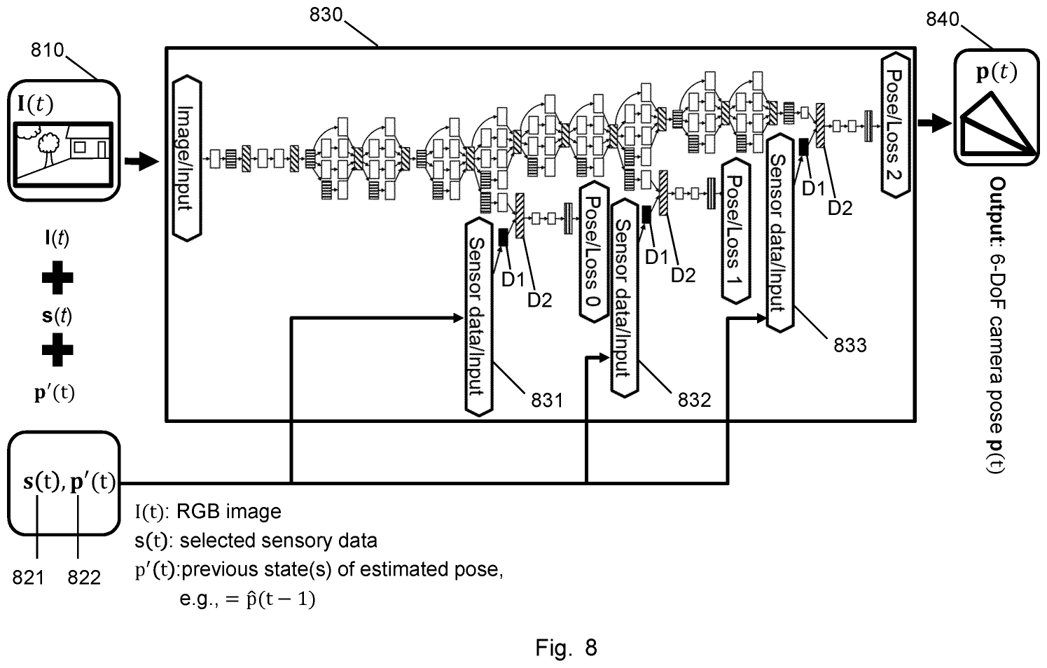

A first approach for adding such extra input(s) is shown in FIG. 8 (wherein more complex architectures such as RNNs are introduced further below). Specifically, FIG. 8 shows an example of a DNN 830 according to examples of embodiments with additional architecture features, thereby fusing image data of an RGB input image 810, IMU data 821, and previous pose state data 822 as inputs (sensor data and previous pose state data inputs 831, 832, 833) of the DNN 830. A 6-DoF camera pose 840 is obtained as output (the DNN structure 830 according to FIG. 8 differs from the DNN structure 730 according to FIG. 7A by comprising the data inputs 831, 832, 833 instead of the data inputs 731, 732, 733).

Moreover, in case AR-supported network service is requested for a new environment, it is detailed below in the present specification to use transfer learning to exploit the knowledge learned from a selected pre-trained environment and accelerate DNN model training for the new environment with limited data.

The estimated camera pose can be then used to project the virtual network information, such as 3D radio map of network performance, onto 2D image with user device's (e.g. a terminal endpoint device's) perspective on the device's display on real-time, to realize the AR features. It is to be noted that unlike the conventional definition of 3D radio map indicating radio signal strength only, the 3D radio map is given a more general definition in the present specification—it can be a position-based map of any performance metrics in radio networks, e.g., received signal strength, data throughput, latency, etc.

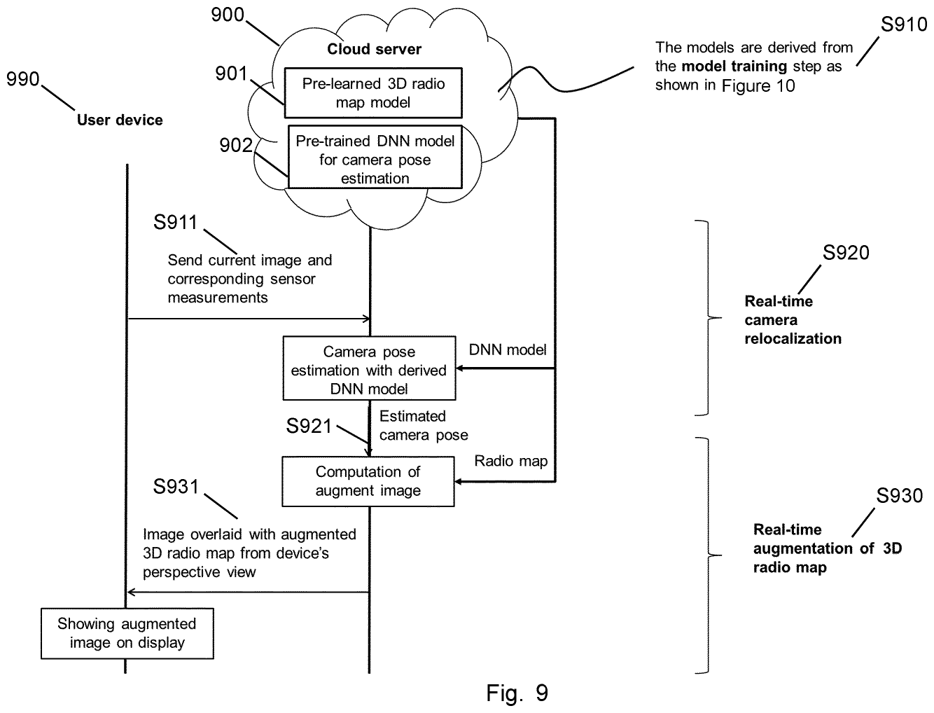

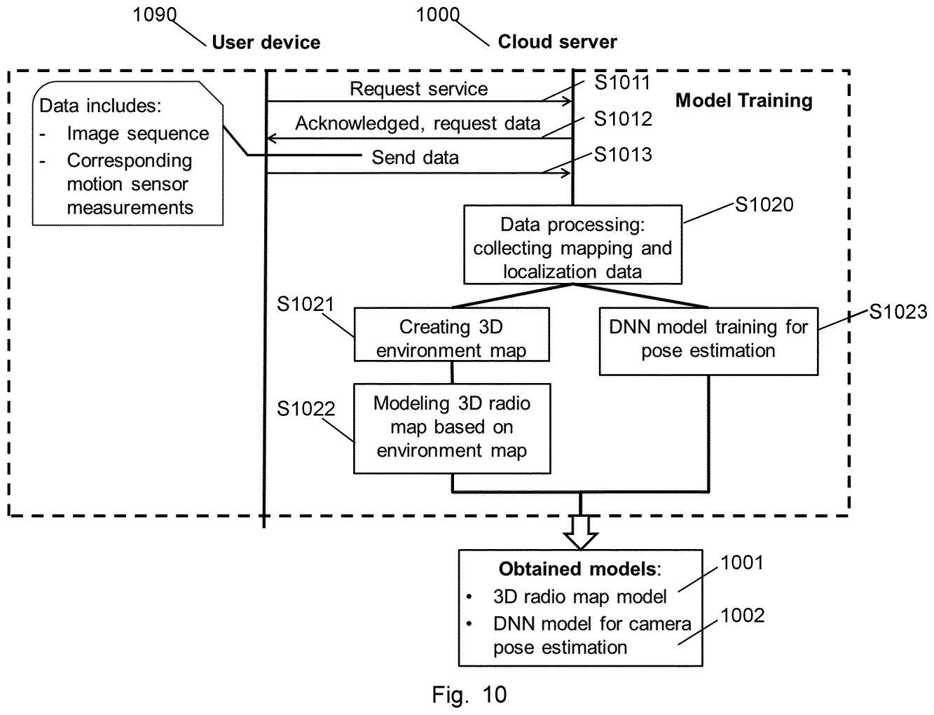

To give a big picture of how camera relocalization enables real-time AR-supported network service visualization, a process of AR-supported network service visualization is described first with reference to FIG. 9. Specifically, FIG. 9 shows a process according to examples of embodiments of AR-supported network service visualization, wherein a pre-learned 3D radio map model 901 and a pre-trained DNN model 902 in server 900 (e.g. a cloud server) are obtained using the process in FIG. 10.

The process consists of following three phases: (1) Model training S910, (2) Real-time camera relocalization S920, (3) and Real-time augmentation of 3D radio map S930.

In the model training step S910, the server collects S911 image data and sensory data from user device 990 and performs the following two tasks, which are as illustrated in detail in in FIG. 10. Specifically, FIG. 10 shows a step of model training according to examples of embodiments. Accordingly, after acknowledgement on a requested service, requested data are send (S1011, S1012, S1013) from the user device 1090 to the server 1000 and the two tasks of data processing S1020 mentioned with reference to FIG. 9 are executed. (1.a) Modeling S1022 the 3D radio map based on the recognition of the 3D environment, wherein the model of 3D environment can be given as prior knowledge or learned/created S1021 from the collected data using 3D environment reconstruction techniques. And (1.b) training S1023 a DNN model with image and sensory data as model input and camera pose as output. As a result, the pre-learned 3D radio map model 1001 (corresponding to the pre-learned 3D radio map model 901 according to FIG. 9) is obtained and the pre-trained DNN model for camera pose estimation 1002 (corresponding to the pre-trained DNN model for camera pose estimation 902 according to FIG. 9) is obtained.

Returning to FIG. 9, in the real-time camera relocalization step S920, given the pre-trained DNN model for camera pose estimation 902, by giving the inputs of image and selected sensory measurements, the DNN model 902 returns S921 the estimated camera pose in real time. In the real-time augmentation of 3D radio map step S930, with the obtained camera pose, the pre-learned 3D radio map 901 is projected S931 onto the 2D display of the user device 990 with the device's view, i.e., realizing the AR features

The problem of camera relocalization can now be stated. The objective is to effectively estimate the camera pose by exploiting the collected image and motion-related sensory data. More specifically, according to examples of embodiments, given an image I(t) captured at time tin a given environment, with its corresponding selected sensory data s(t) collected at the same time t in the same device, it is an object to estimate the camera pose p(t) (camera's position and the orientation defining the view perspective of I(t)) with a pre-trained model f_{w}(I, s), where the index w denotes the parameters characterizing the function f. The model is derived from a training dataset [symbol] ={((I(i), (i), p(i))}ᵢ₌₁^{K}, where a tuple (I, s) is the training input and p is the training output, and K denotes the number of training samples. In the following, first a solution to the above stated basic problem is described. Subsequently, the first solution is extended by adding the previous state of camera pose p′ into the inputs of the estimation model f_{w}(I, s, p′) to predict the current state of camera pose p.

Before introducing each of the solutions according to examples of embodiments in detail, relevant definitions are to be defined for a better understanding first. An image I(t) (e.g. an input image of input image data) can be an RGB image represented by I(t)∈ [symbol] ^{w×h×3}, or a grey-scaled image represented by I(t)∈ [symbol] ^{w×h}, or RGB-D image represented by I(t)∈ [symbol] ^{w×h×4} (where the last dimension includes three colour channels and a depth channel). A camera pose p(t)=[u(t), o(t)] (also referring to a user equipment pose, a terminal endpoint device pose, in case of the user equipment/terminal endpoint device being equipped with a camera (e.g. a camera unit) and/or being connected to a camera (e.g. a camera unit)) consisting of camera's position in 3D space u(t)=[x(t), y(t), z(t)] and its orientation o(t). The orientation can be represented by quaternion o(t)=q(t)∈ [symbol] ⁴, or a 3D vector indicating the camera direction o(t)=d(t)∈ [symbol] ³ in world coordinate system. Sensory data s(t) can be selected from raw or post-processed data collected from the motion sensors embedded in the user device, such as accelerometers, gyroscope, or magnetometer.

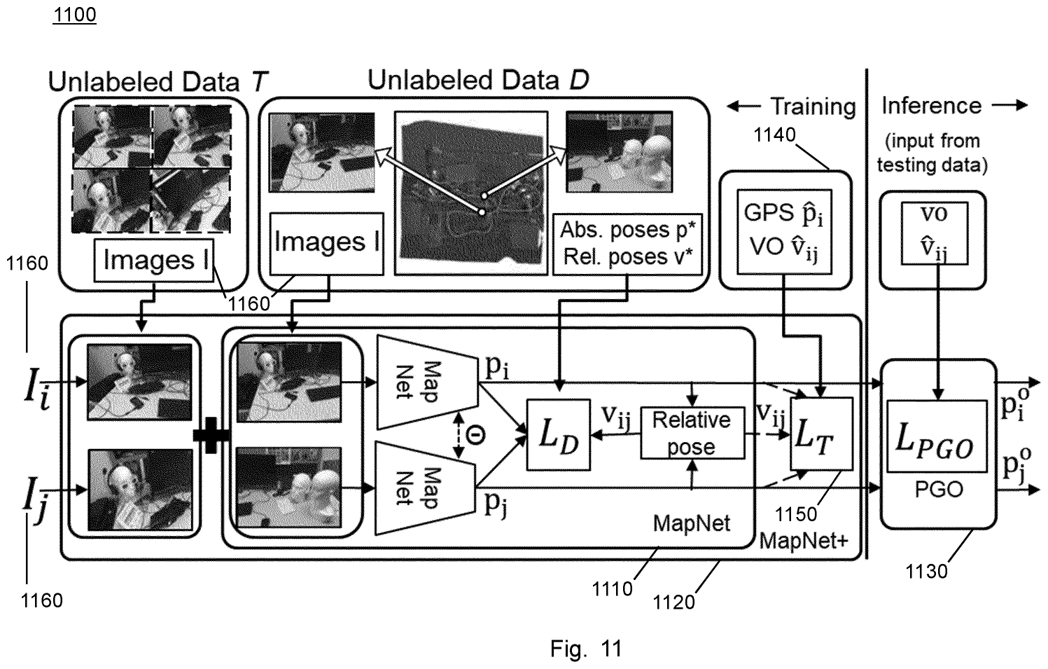

The general idea of the present specification is to use DNN to model the camera pose p as a function f_{w}(I, s) of the fused image data I and sensor measurements s, characterized by parameters w. Unlike the state-of-the-art deep learning approach where only image is used as input [KC+17], the method disclosed herein adds sensory data into the DNN inputs which leads to a major modification to the DNN architecture and information flow. The motivation of using sensory data as additional inputs is that, comparing to images, the motion sensors provide more accurate and direct information about camera's orientation and moving direction. An up-to-date work MapNet [BGK+18] also proposed to introduce the sensory data in a proposed architecture MapNet+. However, different from the solution disclosed herein, they proposed to utilize the sensor measurements (e.g., IMU or GPS) to define additional terms of the loss function, while still using the single image as model input, as shown in FIG. 11. Specifically, FIG. 11 shows a data flow of the MapNet family including MapNet 1110, MapNet+1120, and MapNet+PGO 1130 [BGK+18]. Note that although MapNet+1120 also uses the sensory data 1140, it feeds the sensory data 1140 into an additional term of the loss function LT 1150 to impose a constraint on predicted camera pose, based on the IMU or GPS measurements. The input of the DNN 1100 is still the image data 1160.

As the basis of the DNN proposed herein according to examples of embodiments, there can be used any of the convolutional neural network (CNN) architectures which are usually used for the task of image classification including LeNet, AlexNet, VGG, GoogLeNet (which includes inception modules), and ResNet (which enables residual learning). However, unlike the conventional CNN architectures, whose inputs are solely images, non-image features (a vector derived from the sensory data) as additional inputs are added.

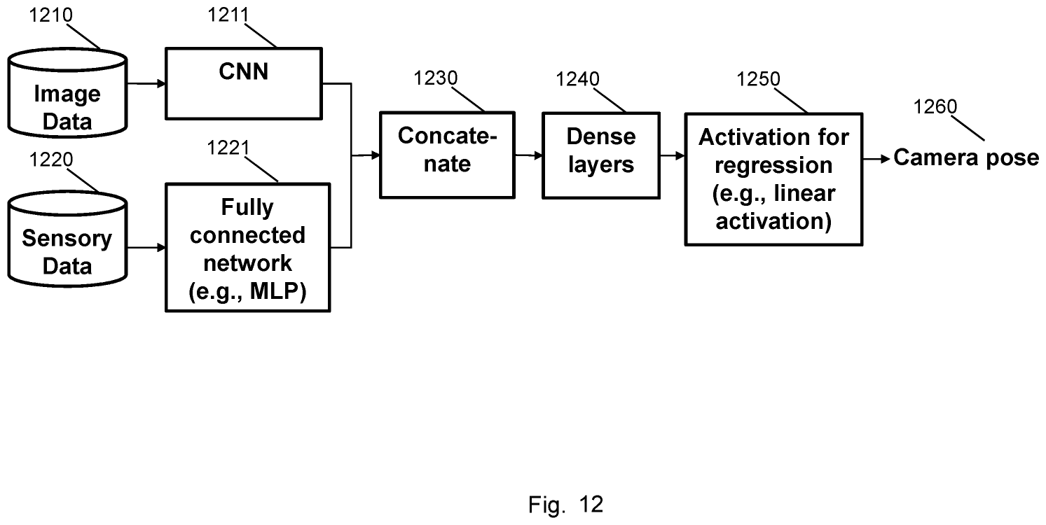

The modification includes the following steps, as shown in FIG. 12, which shows an example of the proposed DNN according to examples of embodiments.

Construct the basic CNN architecture 1211 (fed with image data 1210) and stack the layers till the flatten-layer. Construct a fully connected network 1221 (fed with sensory data 1220) such as multi-layer perceptron (MLP). Concatenate 1230 the outputs of the flattened layer of CNN 1211 and the MLP 1221. Add dense layers 1240 and connect them to the last layer (activation for regression 1250) which represents the predicted vector of camera pose 1260.

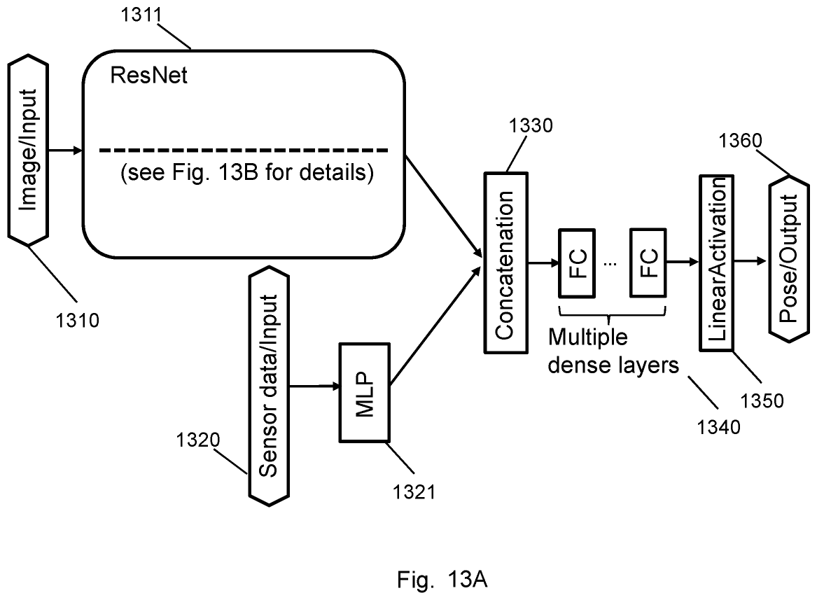

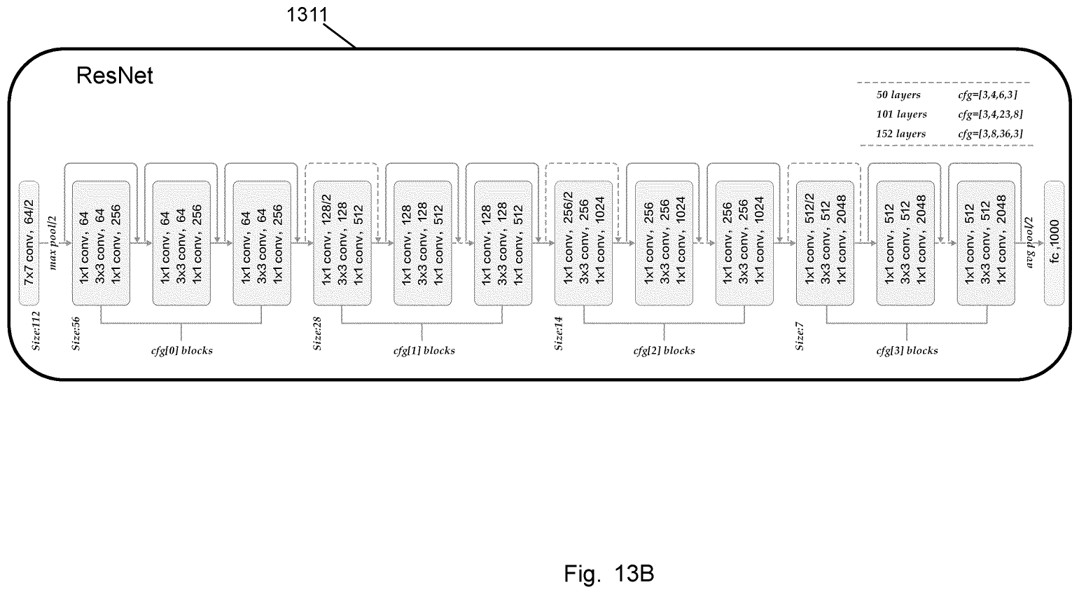

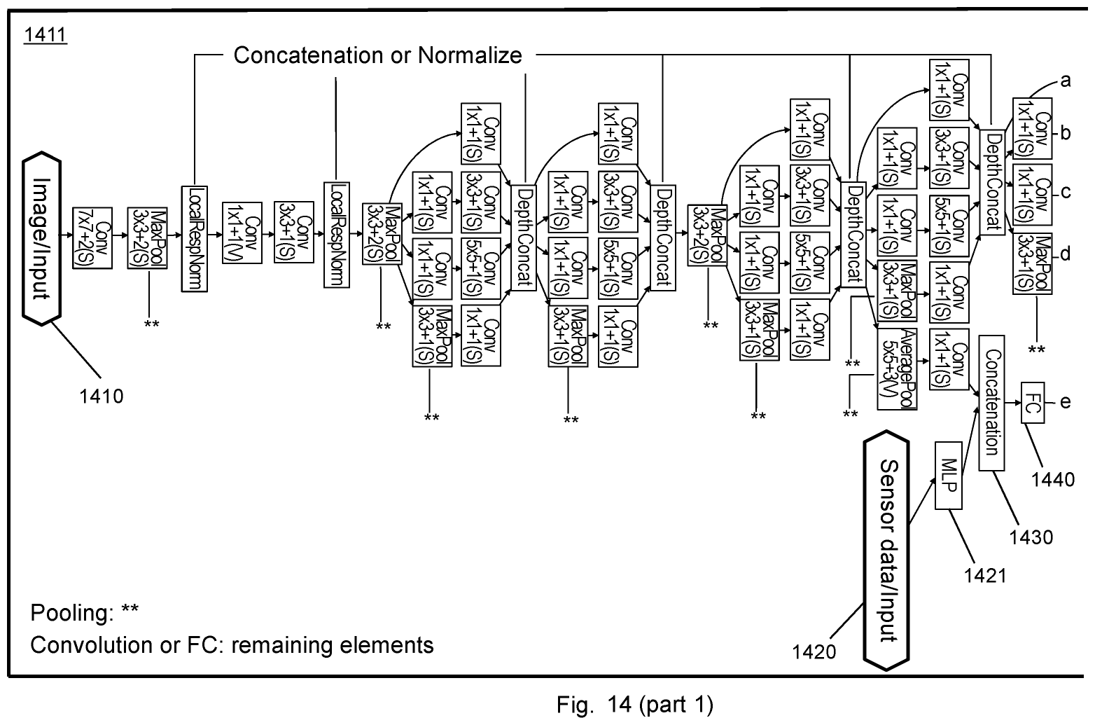

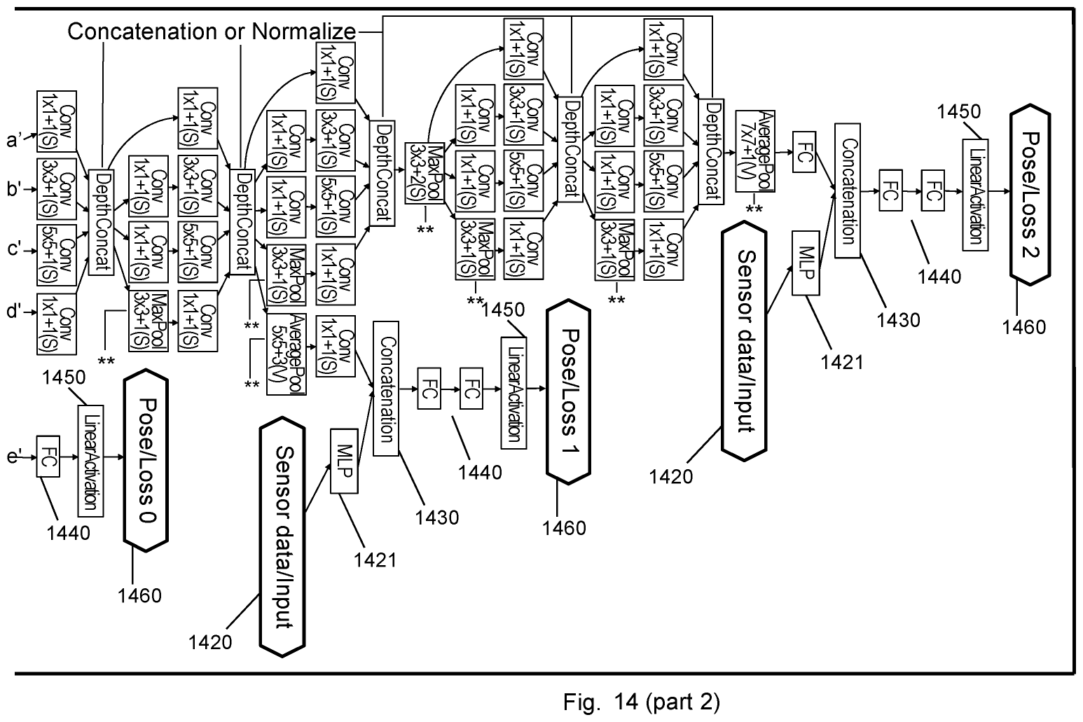

As examples according to examples of embodiments of the DNN models for camera pose estimation with fused data of both image and sensors, the modification of ResNet and GoogLeNet is shown in FIG. 13 (FIGS. 13A and 13B) and FIG. 14, respectively.

Specifically, FIG. 13A shows an example of ResNet 1311 (detailed in FIG. 13B) with additional architecture features (MLP 1321, Concatenation 1330, Multiple dense layers 1340, LinearActivation 1350) according to examples of embodiments, fusing image 1310 and sensor (e.g., IMU) data 1320 as inputs of the DNN, to obtain a pose 1360 corresponding to the inputs as output. FIG. 13B shows an enlarged view of the ResNet 1311 according to FIG. 13A.

Specifically, FIG. 14 (part 1 and part 2; connecting a to a′, b to b′, c to c′, d to d′, and e to e′) shows an example of GoogLeNet 1411 with additional architecture features (MLP 1421, Concatenation 1430, Multiple dense layers 1440, LinearActivation 1450) according to examples of embodiments, fusing image 1410 and sensor (e.g., IMU) data 1420 as inputs of the DNN, to obtain a pose 1460 corresponding to the inputs as output. Note that in GoogLeNet, to overcome the vanishing gradient problem during training, multiple classifiers (regressors in the present case) are added into the intermediate layers, such that the final loss is a combination of the losses in two intermediate layers and the loss in final layer. This is the reason why there are three loss layers and their corresponding sensory data inputs in FIG. 14.

Another question is which sensory data to use as the additional input of the DNN according to examples of embodiments. The optional features are measurements extracted from accelerometer (a 3D vector which measures changes in acceleration in three axes), gyroscope (a 3D vector which measures angular velocity relative to itself, i.e., it measures rate of its own rotation around three axes), and magnetometer (a 3D vector pointing to the strongest magnetic field, i.e., more or less points in the direction of North) [AD+19]. Also the fusion sensors can be considered, e.g., the relative orientation sensor which applies Kalman filter or complementary filter on the measurements from accelerometer and gyroscope [W3+19]. More variants of the features can be extracted or post-processed from the above-mentioned measurements, e.g., it can be derived the quaternion from the fusion sensors. It can also be selected a subset of the features from the above-mentioned sensory data.

The remaining challenge is to collect a valid dataset for training the model according to examples of embodiments. To construct a valid dataset, three types of measurements are needed: images, their corresponding (in the sense that measurements are taken at the same time) sensor measurements, and the camera pose as the ground-truth. The image data and sensor measurements as training input are easy to obtain, for example, through existing Android API. However, the ground-truth of the corresponding camera pose as training output is not easy to derive directly. One option is to use the existing mapping and tracking algorithms such as SLAM, or 3D reconstruction tools such as KinectFusion, to return the estimated camera pose corresponding to the captured image. It can also be used the motion sensor data (e.g., camera orientation derived from the gyroscope and accelerometers, and velocity estimated by the accelerometers) to improve the camera pose derived by SLAM algorithms or KinectFusion.

In the following, detection of information flow is further described.

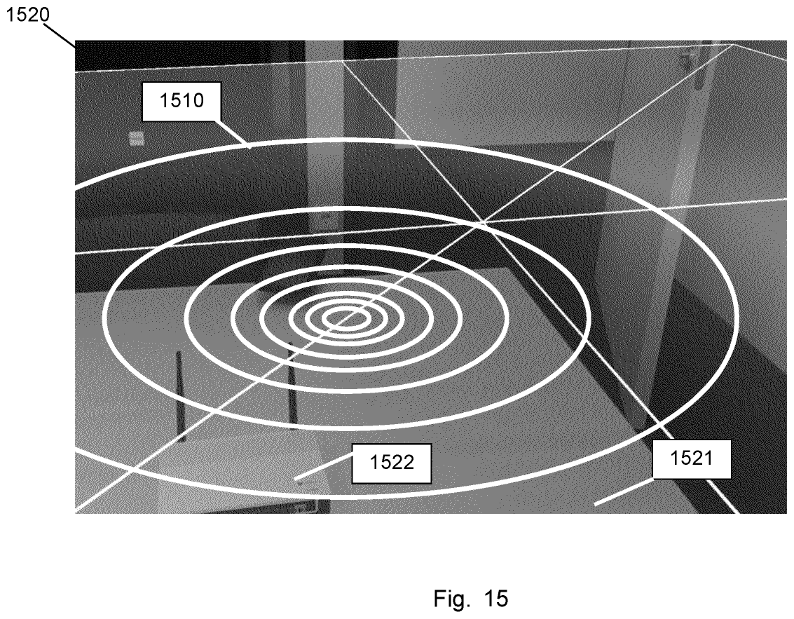

Considering real-time communication between cloud server and user device, an example according to examples of embodiments of the information flow for real-time camera pose estimation and 3D radio map augmentation is shown in FIG. 9. The user device 990 sends S911 the captured image and corresponding sensor measurements to the cloud server 900. The server 900 receives the required data, feeds it into the pre-trained DNN model 902, and outputs S921 the estimated camera pose. Using the camera pose and the pre-learned radio map model 901, the augmented 3D radio map created for the real environment into the 2D image with the view from the device's perspective can be projected. The augmented radio map is then overlaid S931 on the image captured by the camera, sent to the user device 990, and shown on the device's display. FIG. 15 shows an example of projecting radio map on a user device's display according to examples of embodiments. Specifically, similar to FIG. 1, an augmented radio map, highlighted by bolt circles 1510, indicates a location of high availability of radio network resources in an indoor area 1520 (which represents a room including a table 1521 onto which a wireless network modem 1522 is placed generating a real radio network).

The information flow is detectable. The state-of-the-art methods [KC+17] [BGK+18] only request single image sent by the user device for pose estimation, while the method disclosed herein according to examples of embodiments requests both image and the corresponding sensory data. Note that although MapNet+ proposed in [BGK+18] also requires sensory data in the model training phase, because it only use the sensory data for improving loss function (see FIG. 11), in real-time pose estimation it requests from user only the single image but not the sensory data. Moreover, the image overlaid with augmented radio map sent from server to the user device is a unique information which is detectable and differs from other state-of-the-art methods.

Considering local computation in user device, an alternative to the real-time communication between cloud server and user device is to allow the user device to download the DNN model and/or 3D radio map model from cloud server and run the camera pose estimation and radio map augmentation locally. In this case, the models downloaded in the device are easy to be detected.

In the following, camera relocalization using DNN capturing temporal dependency according to examples of embodiments is further described.

As already mentioned above, for enhancing the performance of the DNN proposed above according to examples of embodiments, temporal dependency in the DNN model is to be incorporated. The motivation is rooted in the strong correlation between previous state(s) and current state of camera pose. Moreover, since the raw data of motion sensors usually measures the relative motion from previous state (e.g., relative rotation of sensor frame, angular acceleration, and linear acceleration in world/inertial coordinates), incorporating information of previous state(s) can capture the correlation over time and space.

One option is to add the previously estimated camera pose into the sensory data input, i.e., use [I(t), s(t), \hat{p}(t−1)] as input vector of DNN, where \hat{p}(t−1) is the estimated pose from the previous time slot. It can also be added more previous states into the DNN input [I(t), s(t), \hat{p}(t−N), \hat{p}(t−N+1), . . . , \hat{p}(t−1)] to capture the correlation between current state and previous multiple states. The DNN architecture remains similar to the DNN architecture illustrated in FIG. 12, except for concatenating sensory data and the past N states of the estimated camera pose into one DNN input vector.

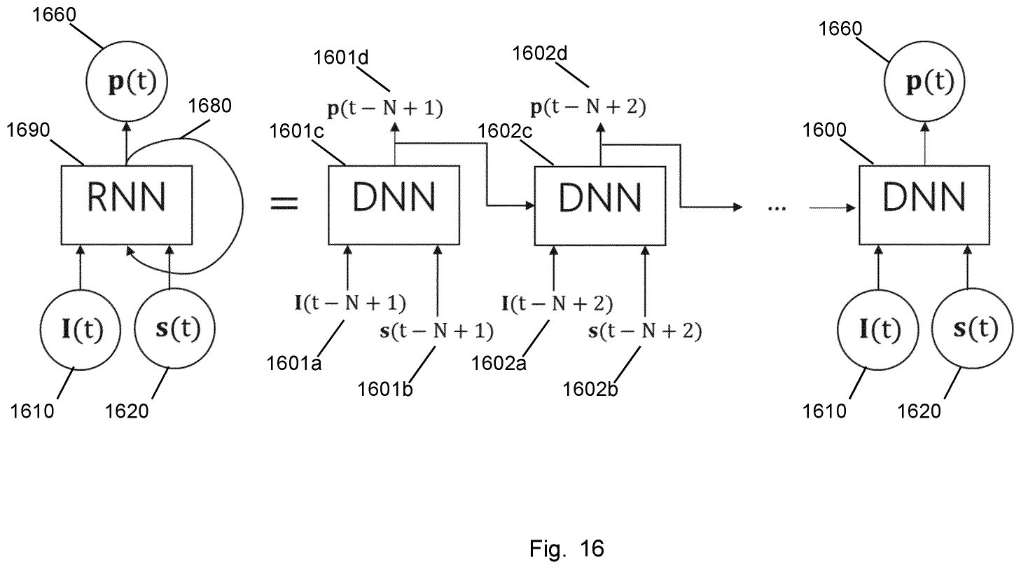

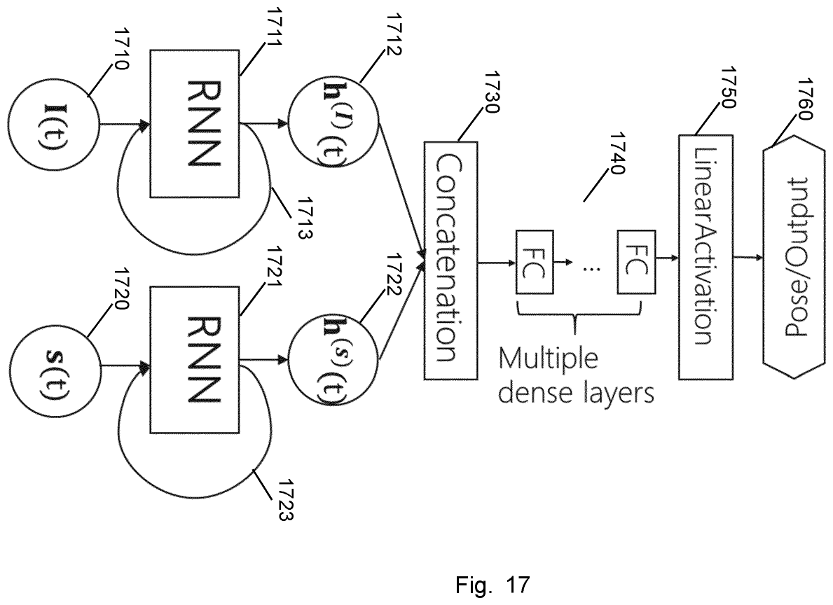

A more complex model is inspired by the concept of recurrent neural network (RNN), which takes both the output of the network from the previous time step as input and uses the internal state from the previous time step as a starting point for the current time step. Such networks work well on sequence data. Taking advantage of the temporal nature of the image sequence and the motion sensor sequence, frame-wise camera pose estimation by using a variant of RNN can be provided. In FIG. 16 and FIG. 17 two RNN architectures for one single RNN cell (for image and sensory data as combined inputs) and two RNN cells (for image and sensory data individually) are provided as examples according to examples of embodiments, respectively.

Specifically, for the RNN 1690 according to FIG. 16, the DNN 1600 on the right-hand side can be built as proposed in FIG. 12 (input image 1610, input sensory data 1620, output pose 1660). Thus, for explanation purposes, image I(t−N+1) 1601a and sensory data s(t−N+1) 1601b acquired at a time t−N+1, respectively are input into the DNN 1601c to obtain a pose p(t−N+1) 1601d corresponding to the time t−N+1 as output. In addition to image I(t−N+2) 1602a and sensory data s(t−N+2) 1602b acquired at a time t−N+2, respectively, also the previously obtained pose p(t−N+1) 1601d is input into the DNN 1602c to obtain a pose p(t−N+2) 1602d corresponding to the time t−N+2 as output. Thus, the feedback-loop 1680 illustrates that for estimating a pose for a point of time, an estimated pose for a previous point of time is used (re-fed).

Specifically, in FIG. 17 two RNN cells 1711, 1721 are formed based on the CNN (using image 1710 as input) and the MLP (using sensory 1720 as input) respectively (see FIG. 12, CNN 1211, MLP 1221) (the recurrent structure is applied to each of the image 1710 and sensory data 1720 individually). Each of the RNN cells 1711, 1721 returns a hidden state 1712, 1722 individually. Then the hidden states 1712, 1722 are concatenated 1730 and fed to some dense layers 1740 to estimate (by application of LinearActivation 1750) the final camera pose 1760. The feedback-loops 1713, 1723, similar to the feedback-loop 1680 according to FIG. 16, illustrate that for obtaining a hidden state for a point of time based on an input image and input sensory data, respectively, of that point of time, a respective previous hidden state is used as additional input (re-fed), respectively.

Other variants of RNN cells can also be considered, e.g., the long short-term memory (LSTM) cell which allows to bridge long time lags and is not limited to a fixed finite number of states.

The information flow is similar as outlined above, except that some buffer memory can be needed in the server or device (depending on whether the computation of camera pose estimation is executed in the cloud or in the local user device) to store the temporary data of the image sequence, sensor measurements, and estimated camera poses of previous states as model inputs.

In the following, fast adaptation to new environment using transfer learning according to examples of embodiments is further described.

This idea applies to the scenario when user enters a new environment, and the new environment is similar to a pre-learned environment with a pre-trained model. Instead of training a new model from scratch, transfer learning can be used to exploit the pre-learned knowledge and accelerate model training for the new environment.

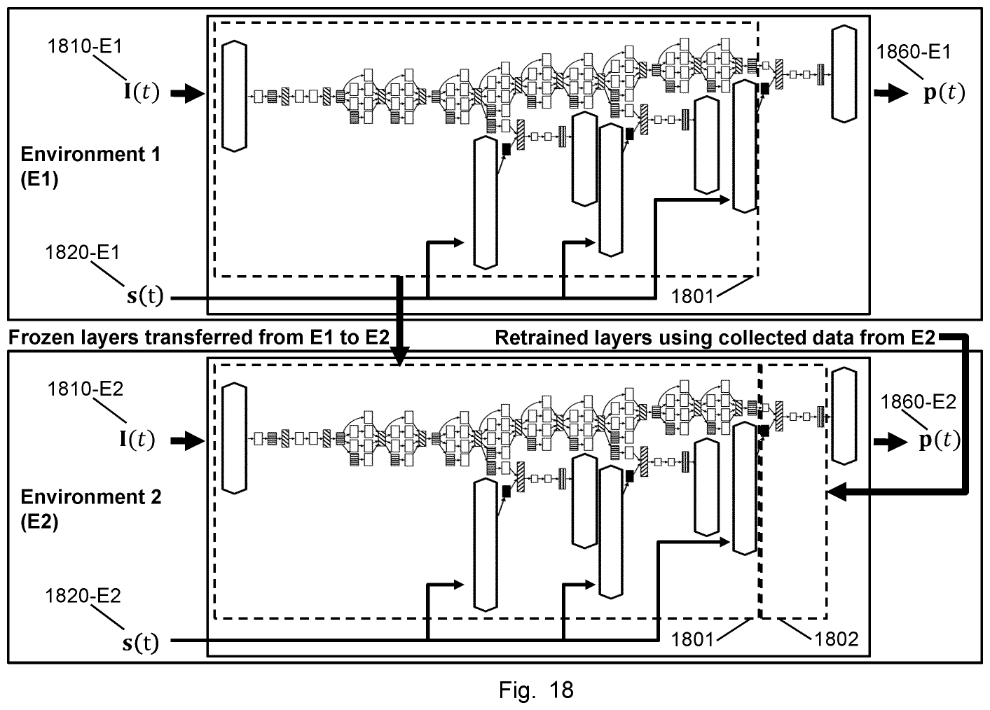

To exploit the knowledge obtained from a previously trained environment and to transfer it to a new environment, partial pre-trained parameters and hyperparameters can be transferred, e.g., those characterizing the lower layers of DNN, as shown in FIG. 18 according to examples of embodiments. As illustrated in FIG. 18, the (lower) layers 1801 to be transferred (in environment E1, encircled in dashed lines, transferred from environment E1 to environment E2) can be selected based on the similarity between the two environments E1, E2. The rest of higher layers 1802 (in environment E2, encircled in dashed lines adjacent to (right-hand side of) the transferred layers 1801) can be remained or modified, then retrained using the data collected from the new environment (images 1810-E1, 1810-E2 and sensory data 1820-E1, 1820-E2 as input with poses 1860-E1, 1860-E2 in environments E1, E2, respectively). It is to be noted that the (lower) layers 1801 to be transferred may correspond to the (lower) layers of the DNN structure 730 according to FIG. 7, which is (mentioned for explanation purposes only) the DNN structure 730 according to FIG. 7 except for the elements indicated by the dashed lined box 1890 illustrated in FIG. 7B (part 2).

The operations of fine-tuning and updating can be achieved with standard transfer learning approach [PQ+10].

Another useful scenario for transfer learning is that, in case of lack of real data, synthetic (e.g. computer simulated) data generated from emulated environment and radio networks can be collected, and pre-train a model for camera pose estimation first. Then, the pre-trained model can be fine-tuned using the measurements in the real environment.

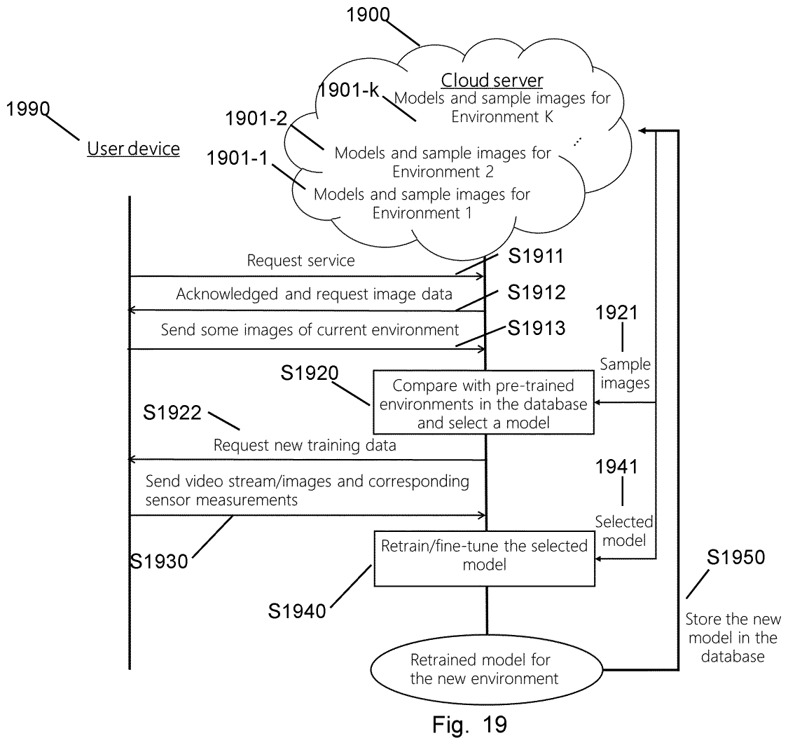

The steps of adapting DNN model to new environment are described according to examples of embodiments as follows, wherein FIG. 19 shows a process of adapting a pre-trained DNN for camera pose estimation to a new environment using transfer learning according to examples of embodiments.

The cloud server 1900 stores a collection of data and pre-trained models for various environments 1901-1 to 1901-k. In particular, for each environment, at least a pre-trained model for camera pose estimation, a pre-learned 3D radio map model, and a set of images describing the environment are stored in the database.

When user device 1990 enters a new environment and requests S1911 AR-supported network service, the server 1900 sends S1912 an acknowledge and asks for some images to compare the new environment with the existing environments in the database.

The user device 1990 sends S1913 a set of the images of current environment to the server 1900. The server 1900 compares S1920 them with the images 1921 describing the existing environments in the database and selects one which is the most similar to the new environment.

Based on the similarity between the new environment and the selected matching environment, the server 1900 requests S1922 different amount of training data from the user device 1990.

The user device 1990 sends S1930 the required amount of data (including both image data and sensory data) to the server 1900. Using transfer learning, the server 1900 retrains/fine-tunes S1940 the pre-trained model of the selected environment 1941 with the data collected from the new environment.

The obtained models for the new environment and the corresponding set of images to describe this environment are then stored S1950 in the database.

The real-time camera relocalization and augmentation of 3D radio map follow the same process illustrated in FIG. 9. Also, similar as described above, the computation of both camera pose and augmented radio map can be executed either in the cloud server 1900 or the user device 1990.

It should be appreciated that
an access technology via which traffic is transferred to and from an entity in the communication network may be any suitable present or future technology, such as WLAN (Wireless Local Access Network), WiMAX (Worldwide Interoperability for Microwave Access), LTE, LTE-A, 5G, Bluetooth, Infrared, and the like may be used; additionally, embodiments may also apply wired technologies, e.g. IP based access technologies like cable networks or fixed lines.
embodiments suitable to be implemented as software code or portions of it and being run using a processor or processing function are software code independent and can be specified using any known or future developed programming language, such as a high-level programming language, such as objective-C, C, C++, C#, Java, Python, Javascript, other scripting languages etc., or a low-level programming language, such as a machine language, or an assembler.
implementation of embodiments is hardware independent and may be implemented using any known or future developed hardware technology or any hybrids of these, such as a microprocessor or CPU (Central Processing Unit), MOS (Metal Oxide Semiconductor), CMOS (Complementary MOS), BiMOS (Bipolar MOS), BiCMOS (Bipolar CMOS), ECL (Emitter Coupled Logic), and/or TTL (Transistor-Transistor Logic).
embodiments may be implemented as individual devices, apparatuses, units, means or functions, or in a distributed fashion, for example, one or more processors or processing functions may be used or shared in the processing, or one or more processing sections or processing portions may be used and shared in the processing, wherein one physical processor or more than one physical processor may be used for implementing one or more processing portions dedicated to specific processing as described,
an apparatus may be implemented by a semiconductor chip, a chipset, or a (hardware) module including such chip or chipset;
embodiments may also be implemented as any combination of hardware and software, such as ASIC (Application Specific IC (Integrated Circuit)) components, FPGA (Field-programmable Gate Arrays) or CPLD (Complex Programmable Logic Device) components or DSP (Digital Signal Processor) components.
embodiments may also be implemented as computer program products, including a computer usable medium having a computer readable program code embodied therein, the computer readable program code adapted to execute a process as described in embodiments, wherein the computer usable medium may be a non-transitory medium.

Although the present disclosure has been described herein before with reference to particular embodiments thereof, the present disclosure is not limited thereto and various modifications can be made thereto.

1-54. (canceled)

55. An apparatus, comprising:
at least one processing circuitry, and
at least one memory for storing instructions to be executed by the processing circuitry, wherein the at least one memory and the instructions are configured to, with the at least one processing circuitry, cause the apparatus at least to:
input display data obtained from a first terminal endpoint device located in a first three-dimensional environment into a deep neural network model for terminal endpoint device pose estimation,
the display data comprising at least
image data of a captured image of at least part of the first three-dimensional environment acquired by the first terminal endpoint device at a first point of time and
sensory data indicative of at least a motion vector of a movement of the first terminal endpoint device in the three-dimensional environment acquired by the first terminal endpoint device at a second point of time,
the deep neural network model being trained with, as model input,
training image data of a captured training image of at least part of a three-dimensional training environment acquired by a training terminal endpoint device located in the three-dimensional training environment and
training sensory data indicative of at least a motion vector of a movement of the training terminal endpoint device in the three-dimensional training environment
and, as model output,
training poses of the training terminal endpoint device in the three-dimensional training environment, and
obtain from the deep neural network model for terminal endpoint device pose estimation, based on the input display data, a first estimated pose of the first terminal endpoint device in the first three-dimensional environment.

56. The apparatus according to claim 55, wherein the first point of time is equal to the second point of time.

57. The apparatus according to claim 55, wherein the at least one memory and the instructions are further configured to cause the apparatus at least to:
add to the display data a previous estimated pose of the first terminal endpoint device in the first three-dimensional environment obtained from the deep neural network model previous to the first estimated pose, and
the deep neural network model being further trained with previous output training poses of the training terminal endpoint device as model input.

58. The apparatus according to claim 55, wherein the at least one memory and the instructions are further configured to cause the apparatus at least to:
add to the display data previous image data and previous sensory data,
the previous image data being image data of a previous captured image of at least part of the first three-dimensional environment acquired by the first terminal endpoint device at a third point of time previous to the first point of time, and
the previous sensory data being sensory data indicative of at least a motion vector of a previous movement of the first terminal endpoint device in the three-dimensional environment acquired by the first terminal endpoint device at a fourth point of time previous to the second point of time, and
the deep neural network model being further trained with previous image data and previous sensory data as model input.

59. The apparatus according to claim 58, wherein the third point of time is equal to the fourth point of time.

60. The apparatus according to claim 55, wherein the at least one memory and the instructions are further configured to cause the apparatus at least to:
project, based on the first estimated pose of the first terminal endpoint device in the first three-dimensional environment, three-dimensional virtual network information onto the captured image, and
generate an augmented reality output image by overlaying the three-dimensional virtual network information with the captured image.

61. The apparatus according to claim 55, wherein the at least one memory and the instructions are further configured to cause the apparatus at least to:
project the three-dimensional virtual network information onto the captured image further based on a three-dimensional virtual network information model for the first three-dimensional environment comprising the three-dimensional virtual network information,
wherein a field of view generated for the three-dimensional virtual network information is configured to be the same as a field of view captured by the captured image.

62. The apparatus according to claim 55, wherein
the apparatus is configured to be integrated in the first terminal endpoint device, wherein the deep neural network model is maintained at the first terminal endpoint device,
or
the apparatus is configured to be integrated in a network communication element, wherein the deep neural network model is maintained at the network communication element.

63. The apparatus according to claim 55, wherein
the captured image is
a two-dimensional image captured by a monocular camera, or
a stereo image comprising depth information captured by a stereoscopic camera unit, or
a thermal image captured by a thermographic camera.

64. A method, comprising the steps of:
inputting display data obtained from a first terminal endpoint device located in a first three-dimensional environment into a deep neural network model for terminal endpoint device pose estimation,
the display data comprising at least
image data of a captured image of at least part of the first three-dimensional environment acquired by the first terminal endpoint device at a first point of time and
sensory data indicative of at least a motion vector of a movement of the first terminal endpoint device in the three-dimensional environment acquired by the first terminal endpoint device at a second point of time,
the deep neural network model being trained with, as model input,
training image data of a captured training image of at least part of a three-dimensional training environment acquired by a training terminal endpoint device located in the three-dimensional training environment and
training sensory data indicative of at least a motion vector of a movement of the training terminal endpoint device in the three-dimensional training environment
and, as model output,
training poses of the training terminal endpoint device in the three-dimensional training environment, and
obtaining from the deep neural network model for terminal endpoint device pose estimation, based on the input display data, a first estimated pose of the first terminal endpoint device in the first three-dimensional environment.

65. The method according to claim 64, wherein the method further comprises the steps of
adding to the display data a previous estimated pose of the first terminal endpoint device in the first three-dimensional environment obtained from the deep neural network model previous to the first estimated pose, and
the deep neural network model being further trained with previous output training poses of the training terminal endpoint device as model input.

66. The method according to claim 64, wherein the method further comprises the steps of
adding to the display data previous image data and previous sensory data,
the previous image data being image data of a previous captured image of at least part of the first three-dimensional environment acquired by the first terminal endpoint device at a third point of time previous to the first point of time, and
the previous sensory data being sensory data indicative of at least a motion vector of a previous movement of the first terminal endpoint device in the three-dimensional environment acquired by the first terminal endpoint device at a fourth point of time previous to the second point of time, and
the deep neural network model being further trained with previous image data and previous sensory data as model input.

67. The method according to claim 64, wherein
in case of the three-dimensional training environment being different from the first three-dimensional environment,
the deep neural network model is used for terminal endpoint device pose estimation in the first three-dimensional environment through transfer learning of the first three-dimensional environment from the three-dimensional training environment.

68. The method according to claim 64, further comprising the steps of:
projecting, based on the first estimated pose of the first terminal endpoint device in the first three-dimensional environment, three-dimensional virtual network information onto the captured image, and
generating an augmented reality output image by overlaying the three-dimensional virtual network information with the captured image.

69. The method according to claim 68, further comprising the steps of:
projecting the three-dimensional virtual network information onto the captured image further based on a three-dimensional virtual network information model for the first three-dimensional environment comprising the three-dimensional virtual network information,
wherein a field of view generated for the three-dimensional virtual network information is configured to be the same as a field of view captured by the captured image.

70. The method according to claim 69, wherein the three-dimensional virtual network information model is provided to an apparatus applying the method.

71. The method according to claim 69, wherein the three-dimensional virtual network information model is learned by an apparatus applying the method from at least part of the display data using 3D environment reconstruction techniques.

72. The method according to claim 69, wherein the three-dimensional virtual network information model is learned by an apparatus applying the method through transfer learning from a pre-learned three-dimensional virtual network information model for a second three-dimensional environment different from the first three-dimensional environment.

73. The method according to claim 64, wherein
the method is configured to be applied by an apparatus configured to be integrated in the first terminal endpoint device, wherein the deep neural network model is maintained at the first terminal endpoint device,
or
the method is configured to be applied by an apparatus configured to be integrated in a network communication element, wherein the deep neural network model is maintained at the network communication element.

74. The method according to claim 64, wherein
the captured image is
a two-dimensional image captured by a monocular camera, or
a stereo image comprising depth information captured by a stereoscopic camera unit, or
a thermal image captured by a thermographic camera.
